(19) United States
(12) Patent Application Publication
(10) Pub. No.: US 2010/0030590 A1
(43) Pub. Date: Feb. 4, 2010

(54) CENTRALIZED MULTI-PROPERTY MANAGEMENT SYSTEM

(76) Inventor: Donald E. Sodaro, Newport Beach, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 12/202,148

(22) Filed: Aug. 29, 2008

Related U.S. Application Data
(60) Provisional application No. 61/085,607, filed on Aug. 1, 2008.

(51) Int. Cl. G06Q 50/00; G06Q 10/00; G06K 5/00

(52) U.S. Cl. 705/5; 705/8; 705/9; 235/382

(57) ABSTRACT

A multi-location management system for hospitality locations includes a multi-unit building connected to a remote control center as an outsourced operation geographically relatively removed from the multi-unit buildings. The center controls several multi-unit buildings for security, occupancy data, vacancy data, and reservation data. There is control of the status of individual units concerning whether access doors to respective units and common areas are open or closed. A centralized guest registration function, guest registration process for any one of a plurality of hotels, and a centralized guest check-in/check-out function are processed at the remote control center. A personal identification number (PIN) is usable for multiple lodging establishments.

### RELATED APPLICATIONS

This application claims the benefit of and priority to U.S. Provisional Application Ser. No. 61/085,607, filed Aug. 1, 2008, and is related to U.S. Utility patent application Ser. No. ______, filed concurrently herewith, the contents of both of which are incorporated by reference herein in their entirety.

### BACKGROUND

This disclosure is generally related to management of multi-room hotels, hostels, and motels. More particularly, this disclosure relates to a system for managing multiple properties from a central remote center.

### SUMMARY

A multi-location management system for hospitality locations includes a multi-unit building connected to a remote control center as an outsourced operation geographically relatively removed from the multi-unit buildings. The center controls several multi-unit buildings for security, occupancy data, vacancy data, and reservation data. There is control of the status of individual units concerning whether access doors to respective units and common areas are open or closed. A centralized guest registration function, guest registration process for any one of a plurality of hotels, and a centralized guest check-in/check-out function are processed at the remote control center. A personal identification number (PIN) is usable for multiple lodging establishments.

In one sense the remote control center undertakes delegated operational functions relating to the multi-unit building and thereby there are relatively less operational functions necessary at the multi-unit building.

There is limited office staff service provided at the multi-unit buildings. Such office staff essentially do not deal with cash transactions relating to guests of the multi-unit buildings and account handling of the multi-unit buildings.

In some forms, there is control of the status of individual units concerning whether access doors to respective units are open or closed, and this can include whether access doors to common areas of the multi-unit building in the multi-property portfolio are open or closed.

### DRAWINGS

The disclosure can be better understood with reference to the drawing figures, in which:

FIG. 1A is an overall system flow plan.

FIGS. 1B and 1C are flow charts connected to each other showing an example of a telecommunications network for the system.

FIGS. 2A and 2B are flow charts connected to each other showing a process for enrolling a guest in the system.

FIGS. 3A and 3B are flow charts connected to each other showing an example of a process for taking a reservation.

FIG. 4 is a flow chart showing an example of a process for checking a guest in at an automatic check-in terminal.

FIG. 5 is a flow chart showing an example of a process for a guest to log in on the Internet.

FIGS. 6A and 6B are flow charts connected to each other showing an example of a process for checking in a guest.

FIGS. 7A and 7B are flow charts connected to each other showing an example of a process for verifying a guest's password.

FIGS. 8A and 8B are flow charts connected to each other showing an example of a process for modifying a reservation.

FIGS. 9A and 9B are flow charts connected to each other showing an example of a process for checking for room availability during a reservation process.

FIGS. 10A and 10B are flow charts connected to each other showing an example of a process for assigning a room to a guest at the time of check-in.

FIGS. 11A and 11B are flow charts connected to each other showing an example of a process for calculating the room rate.

FIGS. 12A and 12B are flow charts connected to each other showing an example of a process for handling guest problems.

FIG. 13 is a flow chart showing an example of a process for giving guests a room choice in the event of partial availability.

FIG. 14 is a graphical representation of the room options provided for a guest during a reservation process.

FIG. 15 is a flow chart showing an example of an interaction of a door switch, motion detector, and employee card reader to advice Central Command (“RCC”) of the room occupancy and door status.

FIGS. 16A and 16B are flow charts connected to each other showing an example of a process for controlling the rooms as to who is in the room and the status of the room.

### DESCRIPTION

The disclosure is concerned primarily with a centralized multiple hotel management system, or a “smart” hotel system. This centralized system or “CenCom” centralizes functions, which include but are not limited to, registration, reservations, check-in, property management, and accounting. Through such a centralized system, a small group of trained employees at a remote central office are able to manage all the major functions for all the hotels. Local management at the individual hotels may then focus their attention on the more specific details of operating their individual hotels. The net result of this is major improvements in operational efficiencies and guest satisfaction.

A centralized multiple hotel management system, CenCom, is disclosed comprising at least one of a centralized guest registration function, a centralized reservation function, a centralized guest check-in/check-out function, a centralized accounting function, and a centralized property management system function.

A multi-location management system is disclosed, comprising a plurality of locations connected to a remote control center. Task function data are transmitted from the individual locations to the remote control center, wherein the task function data are processed at the remote control center.

The multi-location management system for hospitality locations includes a multi-unit building. There are a plurality of hospitality locations connected to a remote control center. The remote control center is located physically separately and removed from the plurality of hospitality locations. The remote control center can be located at a physical place at one time zone of the world clock and the hospitality locations can be physically placed in other time zone locations. The remote control center is a location offsite from the multi-unit building and is an outsourced operation geographically relatively far removed from the multi-unit buildings, and can control several multi-unit buildings.

The hospitality locations each include a multi-unit building. The remote control center includes providing remotely controllable and reportable security for the plurality of hospitality locations. There is a communication connection for transmitting data between the multi-unit buildings and the remote control center.

Additionally, task function data is transmitted between at least one of the pluralities of locations and the remote control center, wherein the task function data is processed at the remote control center. The task function data includes data relating to at least one of occupancy data the multi-unit building, vacancy data of the multi-unit building, and reservation data of the multi-unit building.

The task function data can include data relating to the status of individual units concerning whether access doors to respective units are open or closed. This opening and closure of unit doors can be related to a predetermined time period. The task function data can include data about whether access doors to common areas of the multi-unit building are open or closed. This opening and closure of common area doors can be related to a predetermined time period.

There can be a camera for monitoring selected doors, and a communication link from the camera to a gateway, and in turn a link to the communication connection with the remote control center.

Reports can be transmitted from the remote control center to the multi-unit building. The remote control center undertakes delegated operational functions relating to the multi-unit building and thereby there are relatively less operational functions necessary at the multi-unit building.

The delegated functions to the remote control center include at least one of overall accounting for the multi-unit building, data relating to at least one of occupancy data the multi-unit building, vacancy data of the multi-unit building, and reservation data of the multi-unit building. This can include data on the status of individual units concerning whether access doors to respective units are open or closed, and selectively relating the opening and closure of the unit doors to a predetermined time period. This can further include data of whether access doors to common areas of the multi-unit building are open or closed, and selectively relating the opening and closure of the common area doors to a predetermined time period.

In different cases at least three, six, or all of the operational functions are delegated to the remote control center. The delegating and reporting is affected in substantially real time.

The remote control center provides an integration service at a location offsite and non-contiguous with several of the multi-unit buildings, and is only in essentially regular telecommunication connection with at least several of the multi-unit buildings. The service includes the function of at least the accounting services and security. There is a limited office staff service provided at the multi-unit buildings. Such office staff essentially do not deal with cash transactions relating to guests of the multi-unit buildings and account handling of the multi-unit buildings.

There is a centralized guest registration function, and the remote control center receives data from a guest registration process at any one of a plurality of hotels, and the data is processed at the remote control center. There is a centralized reservation function, wherein data from a room reservation process at any one of a plurality of hotels is received at the remote control center and processed at the remote control center.

There is also a centralized guest check-in/check-out function, and the data from one of a guest check-in or guest check-out process at any one of a plurality of hotels is received at the remote control center and processed at the remote control center.

There is a centralized accounting function, and the data from an accounting process for a plurality of hotels is received by the remote control center and processed at the remote control center. There is a centralized property management system function, wherein data from a plurality of hotels is received by the remote control center and processed at the remote control center.

A self-service transaction system for facilitating reservation and check-in in a lodging establishment comprises a lodging establishment as part of a multi-location system of a plurality of hospitality locations. Each location includes a multi-unit building.

In one form a personal identification number (PIN) is assigned by a computer terminal to a user, the user being at a location remote from the lodging establishment. A request of the user is registered at a self-service terminal at the lodging establishment. The request is at least one of a check-in or check-out request. The request is performed by the self-service terminal if the self-service terminal records entry of a PIN equal to the assigned PIN. The PIN is usable for multiple lodging establishments.

A user at the self-service terminal communicates at least during check-in with the remote control center selectively by at least one of a keying entry, scanning or a dedicated telephone connection.

There is a location-level function resident on a first hospitality location including a multi-unit building, and a network transceiver resident on the first hospitality location, wherein the network transceiver resident on the first hospitality location is connected to a wide area network.

A location-level interface delivers data from the location-level function resident on the first hospitality location to the network transceiver resident on the first hospitality location.

There is a location-level function resident on a second hospitality location which includes a multi-unit building. A network transceiver is resident on the second hospitality location, and the network transceiver resident on the second hospitality location is connected to the wide area network.

A location-level interface delivers data from the location-level function resident on the second hospitality location to the network transceiver resident on the second hospitality location. A remote central server connected to the wide area network, wherein the remote central server receives data from both the network transceiver resident on the first hospitality location and the network transceiver resident on the second hospitality location.

The remote central server integrates the data from both the network transceiver resident on the first hospitality location and the network transceiver resident on the second hospitality location for delivery to a central services application.

A user interface is provided for accessing the central services application and exchanging data between the remote central server and a user. The data includes data relating to the status of individual units concerning whether access doors to respective units are open or closed. This status can be related to opening and closure of unit doors to a predetermined time period. Also the status of whether access doors to common areas of the multi-unit building are open or closed is obtained, and this can be related to whether the opening and closure of common area doors to a predetermined time period.

A centralized multiple hotel management system comprises a plurality of hotel locations each including a multi-unit building connected to a remote control center, the remote control center being located geographically separately from the plurality of locations, wherein the remote control center includes providing remotely reportable security for the plurality of locations. There is a centralized guest registration function, and data from a guest registration process at a hotel is received by the remote control center and processed at the remote control center.

A centralized reservation function, and data from a room reservation process is received by the remote control center and processed at the remote control center, the data from the room reservation process including a personal identification number (PIN) assigned by a computer terminal to a guest.

There is a centralized guest check-in/check-out function, and data from one of a guest check-in and guest check-out process at a hotel is received by the remote control center and processed at the remote control center, the at least one of a guest check-in and guest check-out process data being received from a self-service terminal located at the hotel. The self-service terminal performs one of a guest check-in and guest check-out process if the self-service terminal records entry of data equal to an assigned data record, the data record being usable for multiple hotel establishments.

There is a centralized accounting function, and data from an accounting process at a hotel is received by the remote control center and processed at the remote control center. There is a centralized property management system function, and data from the hotel operation process at the hotel is received by the remote control center and processed at the remote control center.

The assigned data record is at least one of personal identification number (PIN), credit card or debit card information, or bar code information.

The management function includes reports from a remote control center to the hotel locations, and the remote control center undertakes delegated operational functions relating to the hotel locations and thereby there are relatively less operational functions necessary at the hotel locations.

As such, delegated functions to the remote control center include at least one of overall accounting for the locations, data relating to at least one of occupancy data of the hotel locations, vacancy data of the hotel locations, reservation data of the hotel locations, status of individual units concerning whether access doors to respective units are open or closed. This is preferably relating opening and closure of the unit doors to a predetermined time period, whether access doors to common areas of the locations are open or closed, and relating opening and closure of the common area doors.

The hotel locations do not interact with monetary currency between guests of the units and the hotel operation. The hotel locations are established so as not to provide a common area kitchen or dining room.

There is an integration of the management of multiple locations in substantially real-time at a remote control center. There can be remote access from the locations to a single management system to provide data management services to multiple locations.

The multi-location management system includes network transceivers delivering location-level service data to a remote central server accessible by users through a user interface. The locations are connected to the remote central server on a computer network.

Services which are generally not related to the central remote control system would include telephone call accounting, mini-bar, Internet access, and point of sale systems, in-room safe systems, in-room fax systems, parking gate systems, ticketing systems, interactive voice response systems, voice mail, and in-room movies.

There is generally no facility to use the system to purchase other goods or services at or from the hotel. The hotel system is structured to provide rooms or units and charge for those only on a registered basis as controlled by a remoter control center.

In one form, if the lodging provides goods and other services, these other goods such foods from vending machines, movies or the like this is usually set up by the guests directly with such goods and service providers.

Self-service terminals include kiosks within the hotel locations. The kiosk usually includes some kind of reader, scanner, keyboard or the like, screen, which may be a touch screen and may include a computer. The kiosks may be networked to web sites using a TCP/IP or other protocol. Web pages from web sites may be displayed using known and available web software. Guests check in to lodgings using for instance a card reader, and a computer records a request of a traveler. In some cases, an entered personal identification number (PIN) is used by a guest, and this is compared to a previously assigned PIN to the guest. Should the entered PIN match the assigned PIN, then check-in can be affected.

In one form, on check-in a touch screen records guest check-in data and displays information to guests. A scanner or card reader reads the data, PIN or other identification information. There may be a printer to prints check-in/check-out information. The kiosk may include a number of peripherals to enhance check-in options, including readers, and a personal identification number (PIN) keypad, and a character reader. At a central location there is a server for a PIN database, travel database, information about guests, and reservations.

At check-in, in one example, a guest swipes a card through card reader or scans a bar code or enters a PIN. A room key in some form is dispensed from the kiosk or a peripheral associated with the kiosk.

In some cases the kiosk at each location includes a travel application which allows a guest to select a personal identification number (PIN) at the kiosk terminal. In other cases the PIN is pre-assigned by a central remote control center on registering and reserving the room or unit of any one of several lodgings of the systems.

The guest checks out using the kiosk, and a travel application charges final payment for the lodging, and this is processed by the remote control center.

The central remote control center can determine a vacancy, occupancy status of a room or unit. This generating communication signals in response to the status of the room or unit. The digital commands are converted at a gateway device located with the room into other signals to be sent to the central remote control system. The remote control system can monitor the state or condition of whether a door is ajar or closed. This can be of units and also common area doors.

There can be a room environment control device with the room, and this can be connected electronically to the remote control center which can process by the room environmental control to effect efficient use of energy by controlling a room environmental device, and in keeping with the preferences of guests. A guest's desired environmental settings can be determined or profiled, and stored centrally at the remote control center. In this manner, a guest's comfort is simplified and enhanced for each unit at which the guest will stay. In one form of effecting energy efficient usage in a unit, the vacant or occupied status of the unit generates signals to a gateway device located with the room. The room environment control device receives the signals which are then transmitted though a communication network to the remote control center.

In one exemplary implementation, a multi-location management system for hospitality locations, including hotels, is disclosed, comprising a plurality of hospitality locations connected to a remote control center, the remote control center being located physically separate from the plurality of hospitality locations. The remote control center provides remotely controllable and reportable security for the plurality of hospitality locations. The system also includes task function data transmitted from at least one of the plurality of locations to the remote control center, wherein the task function data is processed at the remote control center.

In another exemplary implementation, a centralized multiple hotel management system is disclosed. The centralized multiple hotel management system comprises a plurality of hospitality locations connected to a remote control center, the remote control center being located physically separate from the plurality of hospitality locations. The remote control center also provides remotely controllable and reportable security for the plurality of hospitality locations. The system also includes a centralized guest registration function, wherein data from a guest registration process at a hotel is transmitted to the remote control center and processed at the remote control center. There is also a centralized reservation function, wherein data from a room reservation process is transmitted to the remote control center and processed at the remote control center, the data from the room reservation process including a personal identification number (PIN) assigned by a computer terminal to a guest. Also included is a centralized guest check-in/check-out function, wherein data from a guest check-in or guest check-out process at a hotel is transmitted to the remote control center and processed at the remote control center. The guest check-in or guest check-out process data is sent from a self-service terminal located at the hotel, where the self-service terminal performs the guest check-in or guest check-out process if the self-service terminal records entry of a PIN equal to the assigned PIN. The PIN is usable for multiple lodging establishments. The system also includes a centralized accounting function, wherein data from an accounting process at a hotel is transmitted to the remote control center and processed at the remote control center. There is also a centralized property management system function, wherein data from a hotel operation process at the hotel is transmitted to the remote control center and processed at the remote control center.

In one aspect of the present disclosure, there is a centralized guest registration function. Guests preferably only have to register once to be registered at every or most participating individual hospitality properties or locations.

Registration is a difficult function in the lodging industry and a major source of guest dissatisfaction. Extensive training requirements, high employee turnover and absenteeism combined with the current complex computer management systems have made the front desk function very difficult. It is also a 24 hours-a-day 7 days-a-week function that limits the salaries that can be paid but is associated with high guest volatility. Guests often come in large groups, so while a desk clerk may spend a great deal of time in idleness, there are also periods of frenzied activity, much to the guests' annoyance.

The centralized guest registration function of a remote control center (RCC) helps reduce guest annoyance and large costs to the hotel, by allowing a small group of employees at a remote central office to effectively manage the front desk registration process for the properties and lodgings. This should further by eliminate the need for repeat registrations from returning guests. The individual lodgings and hotel operational cost inefficiencies associated with the fluctuations between idleness and activity at the front desk of each lodging is reduced. A plurality of hotels and lodgings has their front desk activities outsourced to employees at the remote central office. These employees at the RCC can remain actively busy for multiple lodgings.

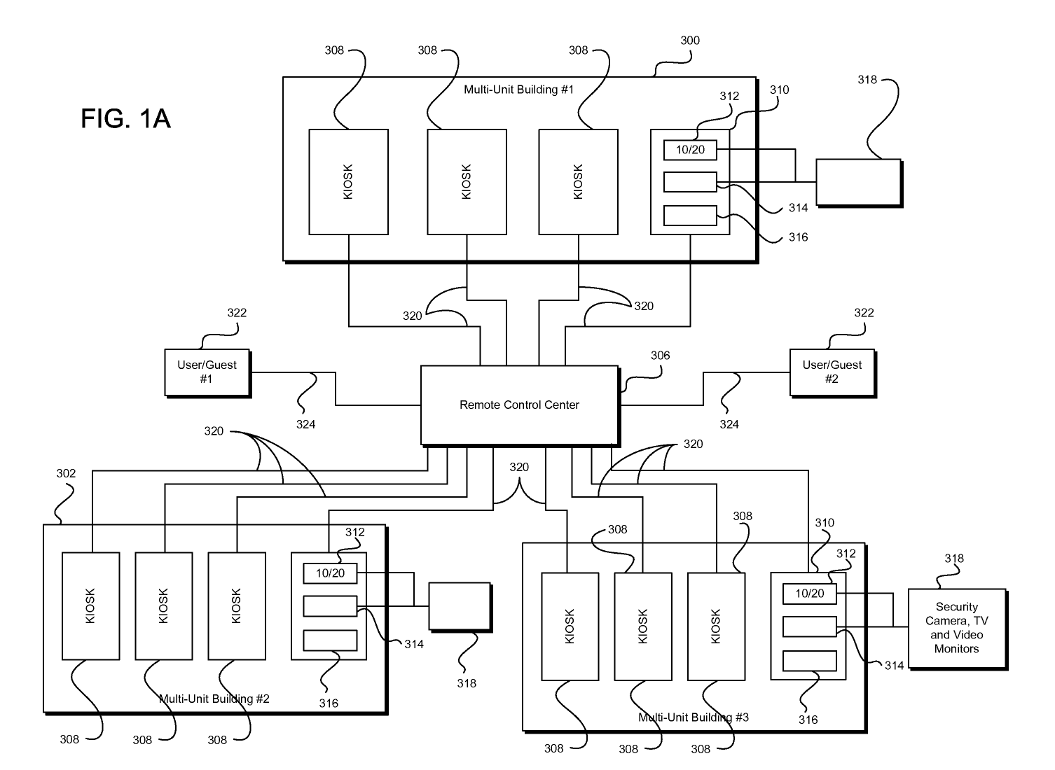

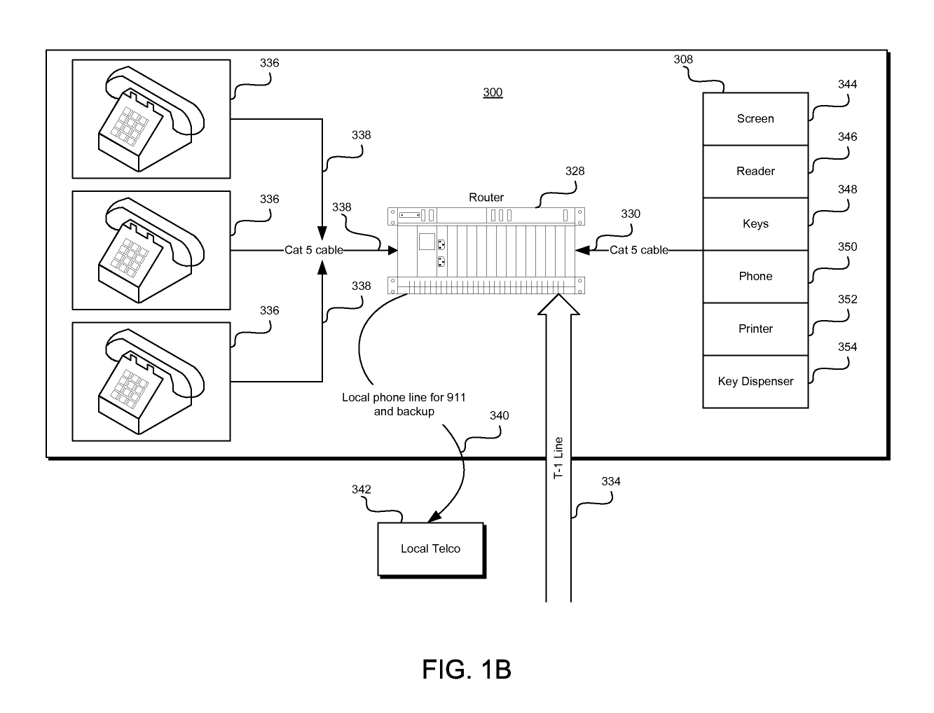

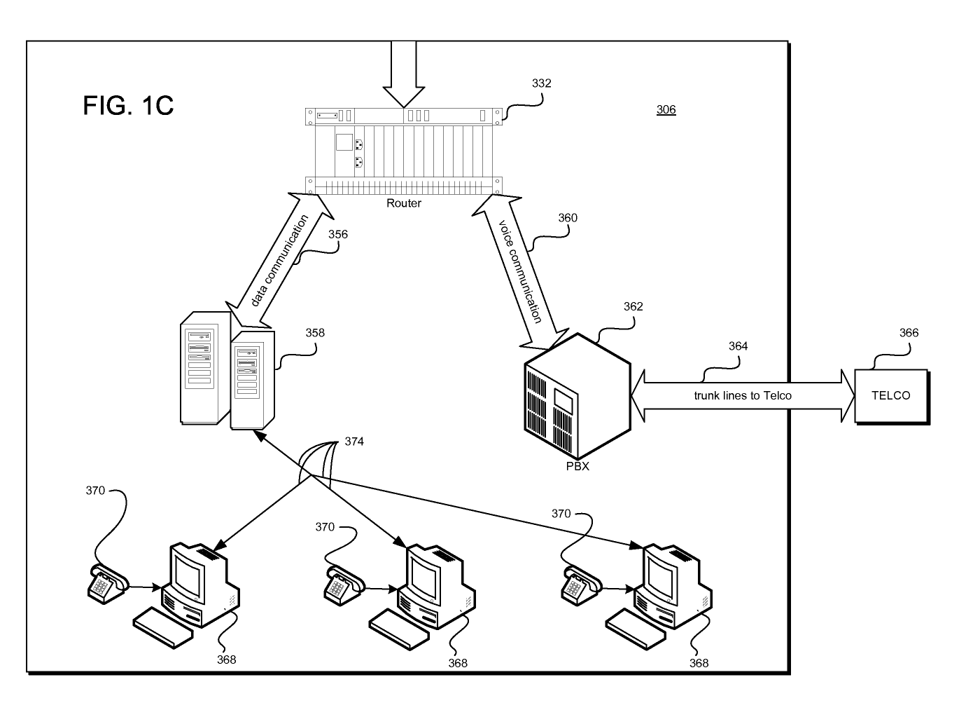

As shown in FIG. 1A there are three buildings, such as hotels, 300, 302 and 304 connected to a Remote Control Center (RCC) 306. In each of the buildings 300, 302 and 304 there are three kiosks 308 for check-in and check-out purposes. Also in each building as represented by block 310 there are the networks, routers and hardware and systems for permitting control and communication with the RCC of the buildings 300, 302, and 304.

In each of the blocks 310 there are three other blocks which represent the following: block 312 for systems for monitoring the security of individual doors of individual rooms and units 10 and 20 in each hotel 300, 302, and 304, block 314 for monitoring the security of common area doors in each hotel 300, 302, and 304. Block 316 represents systems, hardware and applications for back office accounting protocols and procedures for each hotel 300, 302, and 304. The blocks 312 and 314 are connected with a block 318 which represents security cameras, TV monitors and videos systems which can monitor and sense the condition of doors in units and common areas as needed. Each of the systems in each of the hotels 300, 302, and 304 are connected with the RCC 306 through a telecommunication system represented generally by lines 320.

Guests 322 and 324 from outside of the hotels communicate their requirements with the RCC 306 as needed along telecommunication lines 324. In some cases the guests can already be in a unit 10 or 20 and through their own computer systems and/or phones they would communicate with the RCC 306. The different forms of communications between the guests 322 and 324 with the RCC 306 include issues of registering in the system, making and changing reservations at different hotels 300, 302 and 304.

FIGS. 1B and 1C show the kiosks 308 in communication with a router 328 in a hotel 300, for instance, through line 330. The router 328 is in turn in communication with a router 332 in the RCC 306 through a T1 line 334. At the hotel 300 there are also telephones 336 which communicate with the router 328 through lines 338. There is local telephone line 340 connected with a local Telco 342.

The kiosk 308 at the hotel 300 includes the features of a screen 344, bar code and/or magnetic strip reader 346, keys 348 for inputting data, a phone 350 which may be dedicatingly connected with the RCC 306, a printer 352 and key delivery system 354. The RCC 306 can have the reader 346, keys 348, phone 350, printer 352 and key delivery system wholly or partly integrated into a single or two or more stand alone units electronically connected. One or more of the components can be a peripheral unit. The screen can be a touch screen. The printer may be built into the kiosk housing cabinet and be part of an integrated kiosk. The reader can read one or more different kinds of magnetic data record on a suitable identifying card or license.

At the RCC 306 the router 322 is in data communication along line 356 with computer servers 358. Voice communication along line 360 is transmitted to a PBX 362 and in turn through trunk lines 364 to a Telco 366. There are multiple workstations 368 and telephones 370 for operators at the RCC 306. These are all interconnected through lines 374.

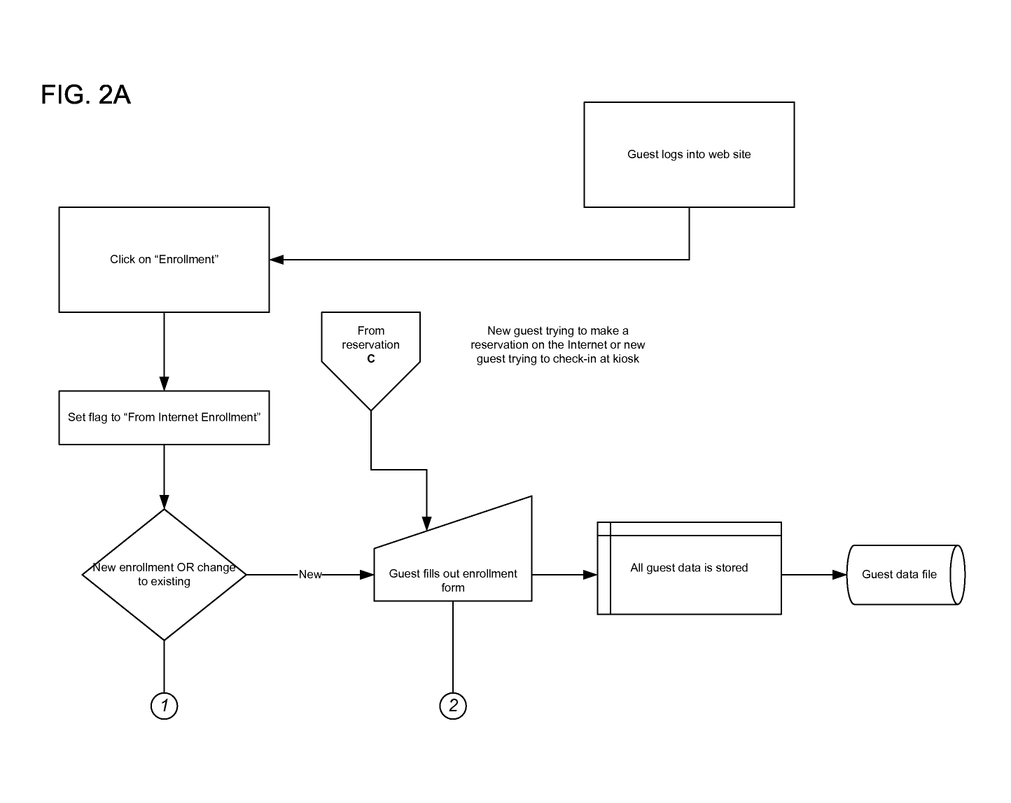

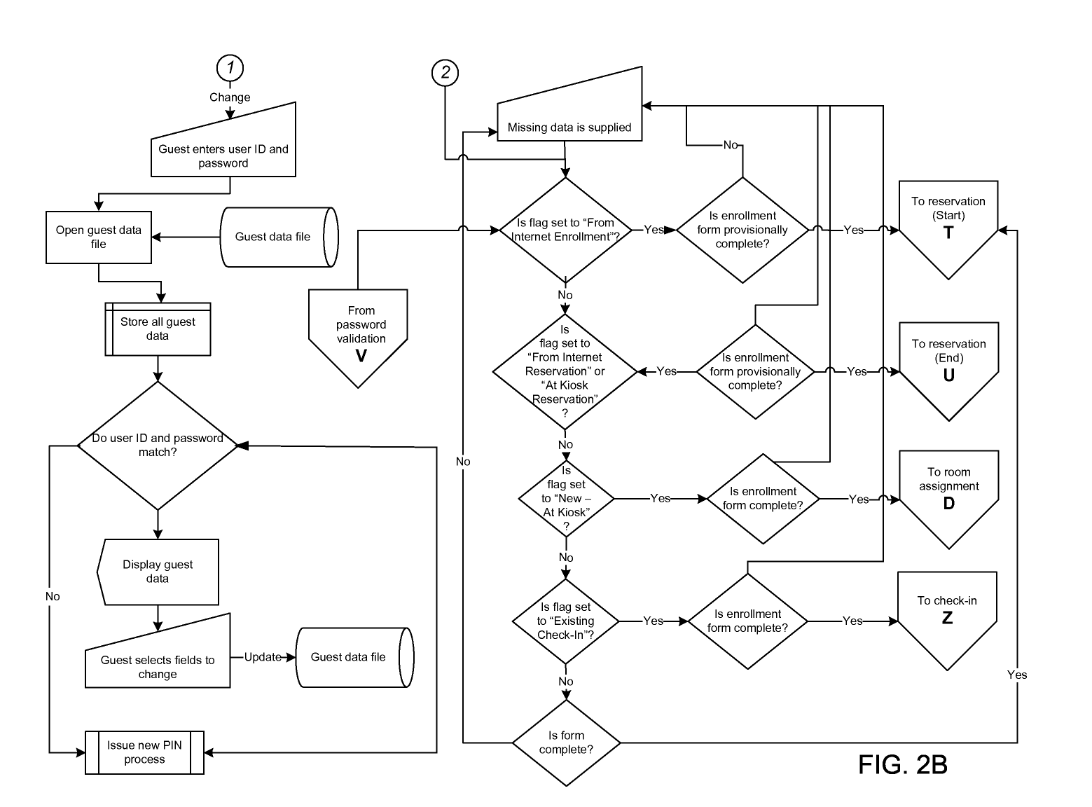

FIGS. 2A and 2B show an example of how a guest enrolls or registers in one of three ways: on the Internet, at the kiosk on the property, or by phone to the RCC. There is shown the enrollment process and also aspects about making a reservation at a kiosk 308.

In one embodiment, the guest enrolls prior to taking any other action, but does only enroll or register once. When the guest enrolls, a PIN can be assigned to the guest for future use. This would include selecting a user name and assigning a dedicated password to the guest user for subsequent access to the system. The system also stores the appropriate bibliographic and profile data of the guest. The guest can update the personal data as needed. There is the ability also to start a reservation process, end a reservation process, and have a room assigned.

After the guest is enrolled, the guest is “in the system” forever, or if there are reasons for excluding the guest from the system, the registration can be cancelled. If the guest is a “bad actor” or has created problems at a hotel, the guest enrollment file can be marked by RCC personnel and the guest can be blocked from the system.

The RCC can be implemented nationwide and/or internationally and/or through different time zones. The participating hotels can be located in different time zones, for even greater efficiencies. Commonly, the peak hours of front desk activity occur between 6 PM and 9 PM, when the majority of guests check in. In one example, while many people are checking in on the East Coast of the United States, things should be quiet on the West Coast and just building up in the Midwest. This system in effect allows RCC to “move” the front desk staff across the country to where there is more guest activity buildup, effectively focusing resources to where the front desk is most needed. As more and more guests use the Internet to register on the RCC, staff involvement in the registration process should diminish appreciably.

In another aspect of the present disclosure, the RCC includes a centralized reservation function. Once a guest has registered, they may then make reservations through the RCC by methods such as over the phone, by facsimile, or through the Internet. These methods may be multilingual in order to accommodate guests from all nationalities. Pricing policies may be implemented to encourage guests to use a certain type of reservation method, such as using the Internet. Reservations may also be performed even if the guest is already located at the hotel.

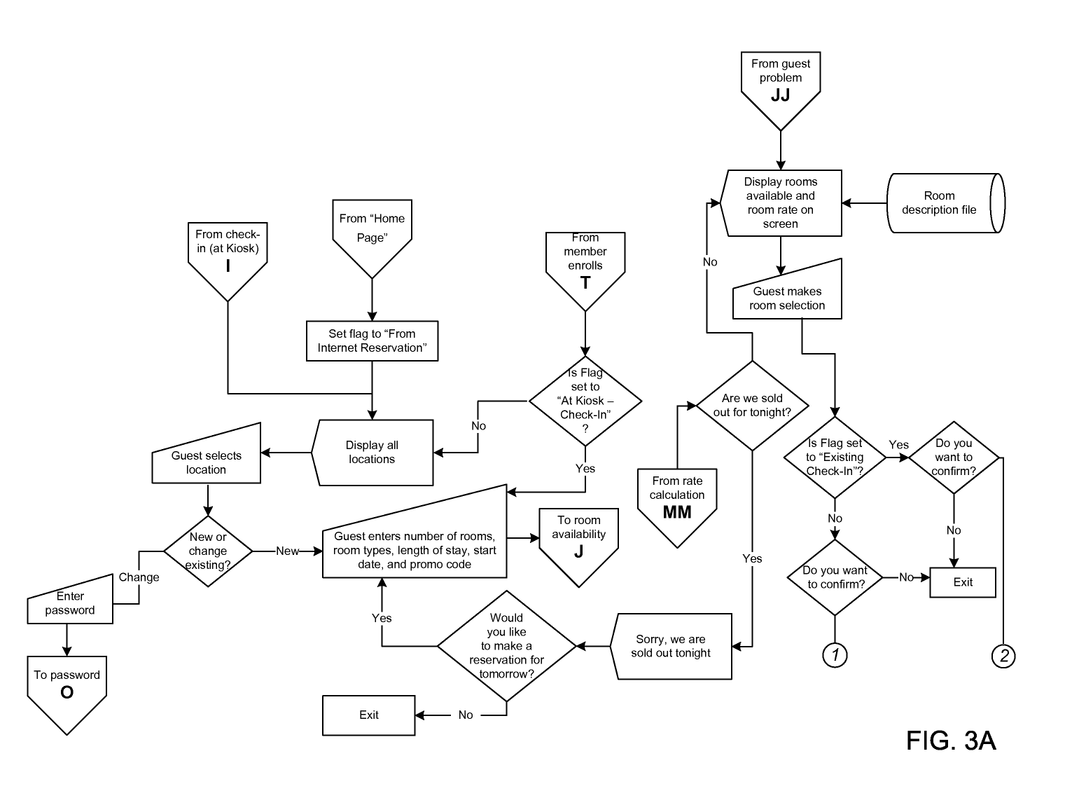

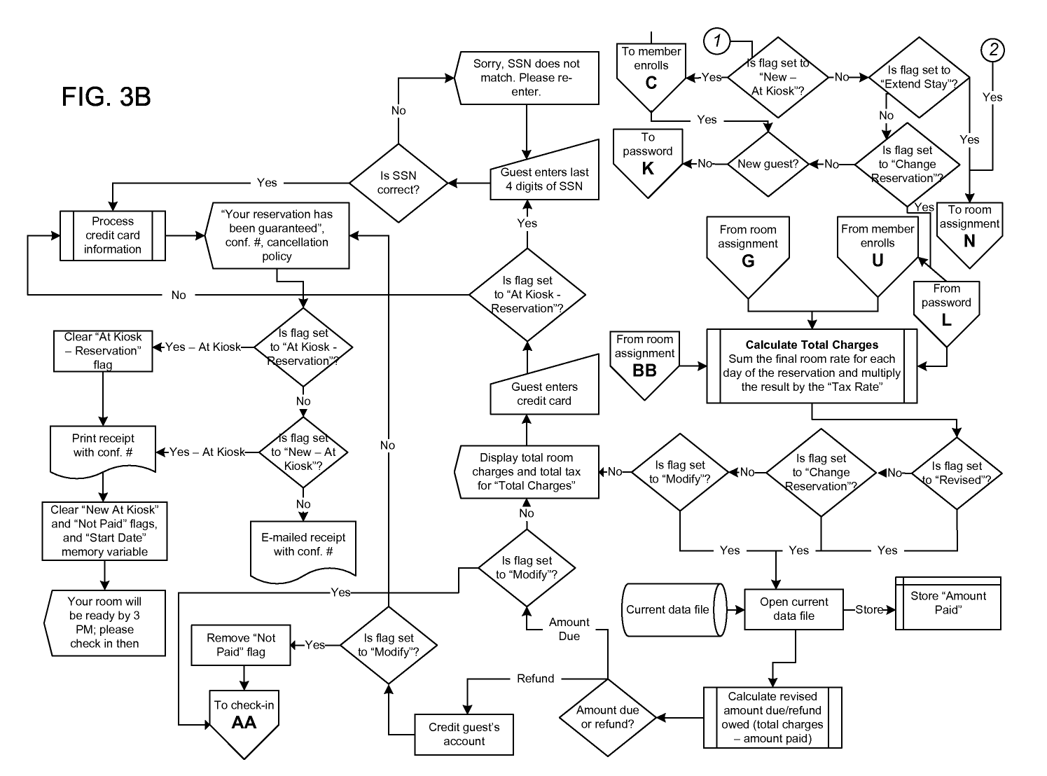

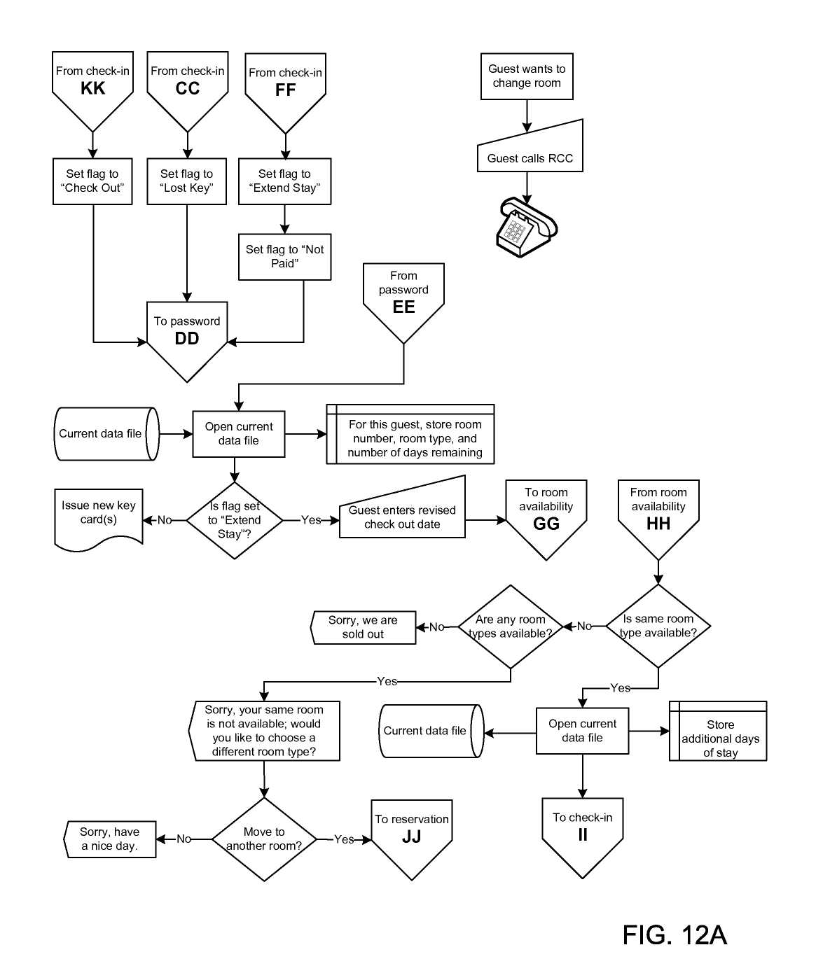

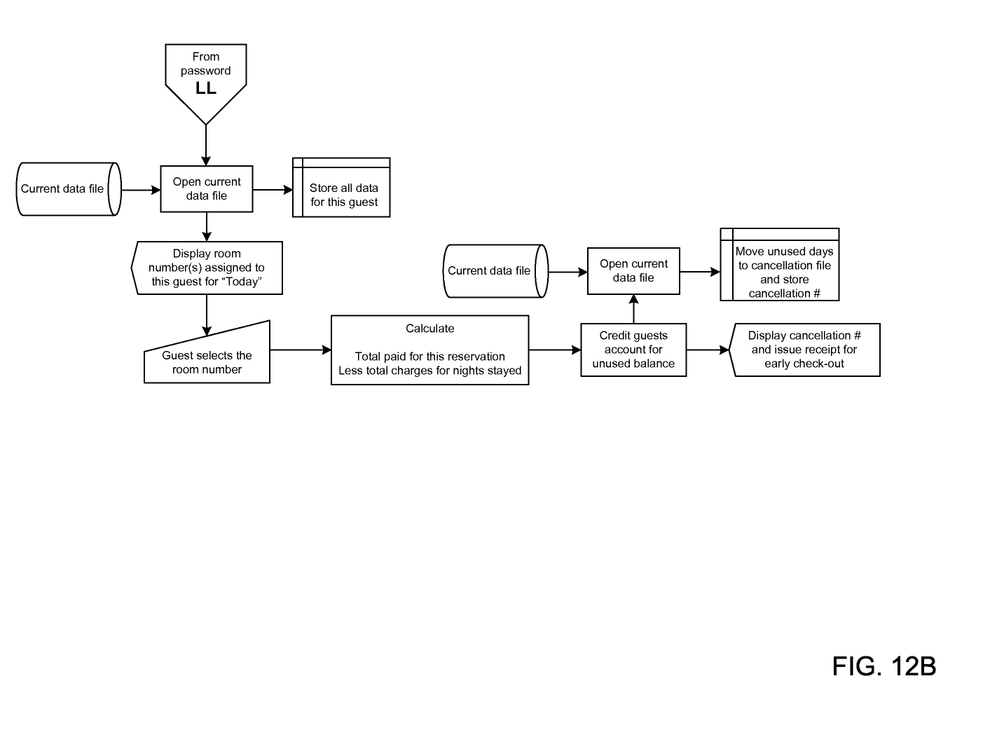

FIGS. 3A and 3B show an example of how once a guest is enrolled, namely registered, the guest can make a reservation, even if it is for the same day. The reservation may come in from several sources, including but not limited to, the self-service terminal or kiosk, the Internet, a RCC operator talking to the guest over the phone, from the enrollment or registration process, or from the “guest problem” flow chart. See FIGS. 12A and 12B.

The registration process shown in FIGS. 3A and 3B includes taking the request, verifying the password, searching the current data file to ascertain if rooms are available to fulfill the requested reservation, calculating the total charges and, if confirmed by the guest, making the reservation and confirming it.

The guest pays for the reservation via credit card at the time the reservation is confirmed, and the system processes the payment, and can attend to refunds as needed. As such, there is no need for later payment at the hotels 300, 302 and 304, and the hotels are thereby set up in a manner so as to not handle payment transactions. This is done centrally through RCC 306. If an upgraded room is required or a change in room, this is done through a kiosk 306 at the hotel or by a guest through the guests own computer or telephone interaction with the RCC 306.

In FIGS. 3A and 3B different features are shown that are possible including check-in, determining the number of rooms needed and when and where, room availability and assignment, emailing receipts, checking identity of the guest, and calculating charges.

The RCC includes a centralized check-in/check-out function. In one embodiment, a guest may check-in at an automated kiosk which is connected to the RCC. This connection may be through the Internet.

A self-service transaction method is disclosed comprising the steps of establishing a personal identification number (PIN) assigned by a self-service terminal to a user at a lodging location, and recording for a reservation at any lodging a request of the user at a lodging location. The request is performed by the self-service terminal if the self-service terminal records entry of a PIN equal to the assigned PIN.

In one exemplary implementation, a self-service transaction method to facilitate reservation at a lodging establishment is disclosed. The method comprises the steps of establishing a personal identification number (PIN) assigned by a computer terminal to a user. The user is at a location remote from the lodging establishment. A request of the user for check-in is made at a self-service terminal at the lodging establishment. In some cases, the request being at least one of a check-in and check-out request. The request by the user is conducted at the self-service terminal if the self-service terminal records entry of a PIN equal to the assigned PIN, the PIN being usable for multiple lodging establishments.

In different situations, the guest can call from the dedicated phone at a kiosk to connect by voice with the RCC and effect check-in or other transactions with the RCC.

In one example, when a guest arrives at the hotel, the guest finds that there is no “front desk” but only a concierge desk and several kiosks with phones attached. The experienced guest will go to the “express check-in” kiosk, enter his ID number, swipe his credit card or drivers' license, or scan his reservation bar code. A receipt will be printed with his room number on it and a magnetic key card will be printed. The guest then can open the door to the corridors and elevator and go to his room.

Another guest, not familiar with the system, would merely pick up a phone at the kiosk and personnel at the RCC would check that person in. Both the kiosk and the RCC personnel may be able to converse with the guest in his preferred language. Management staff at the property would also be available to provide whatever additional assistance the guest may need.

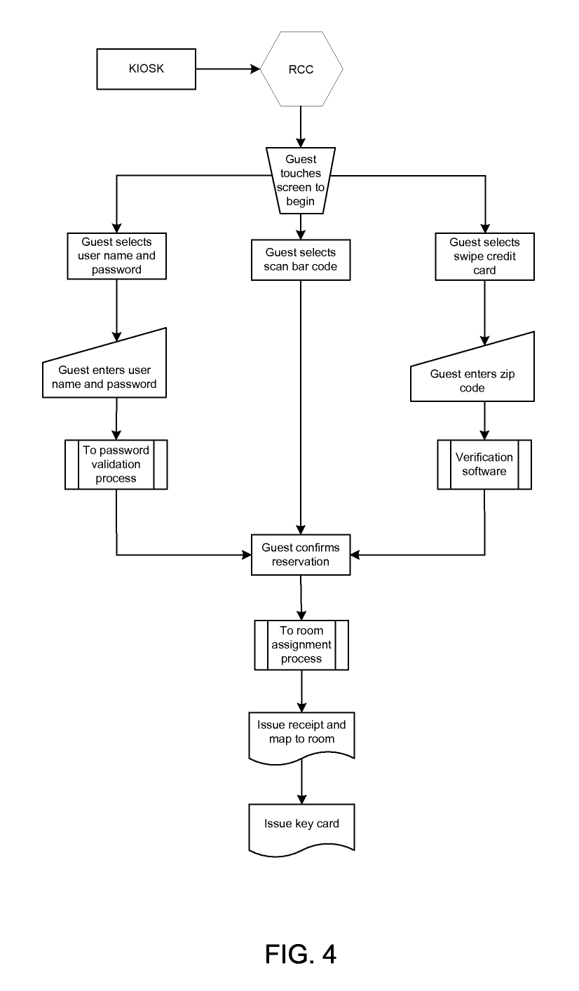

FIG. 4 shows an example of a process a guest can take when checking in at a self-service terminal or kiosk. The guest is first prompted to touch the screen to begin. There are then three different ways in which the guest verifies identity and retrieves the reservation: the guest enters the username and password, the guest swipes the credit card and is then prompted to enter in the zip code for authorization, or the guest scans the bar code that is printed on the verification e-mail that was received when the reservation was made.

The guest then confirms the reservation, for instance, room type and length of stay, and is then issued a room key and receipt, and a map to the room.

Other ways of checking in include swiping a credit or debit card or having a driver's license scanned or read by the kiosk 306. Other forms of identity such as ID books or passports could be used.

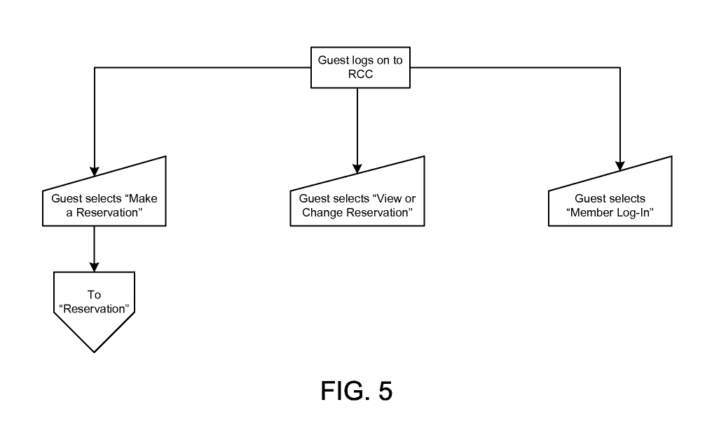

FIG. 5 shows various options that the guest encounters after going to an example website which requires them to either enroll as a member or sign-in in order to view, make or change a reservation.

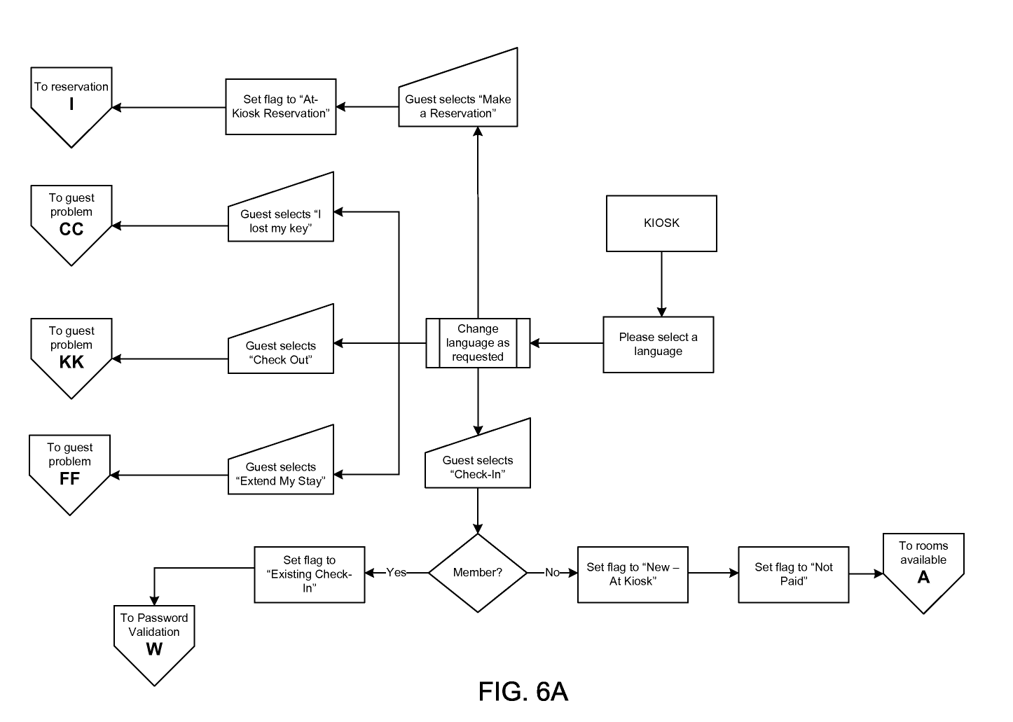

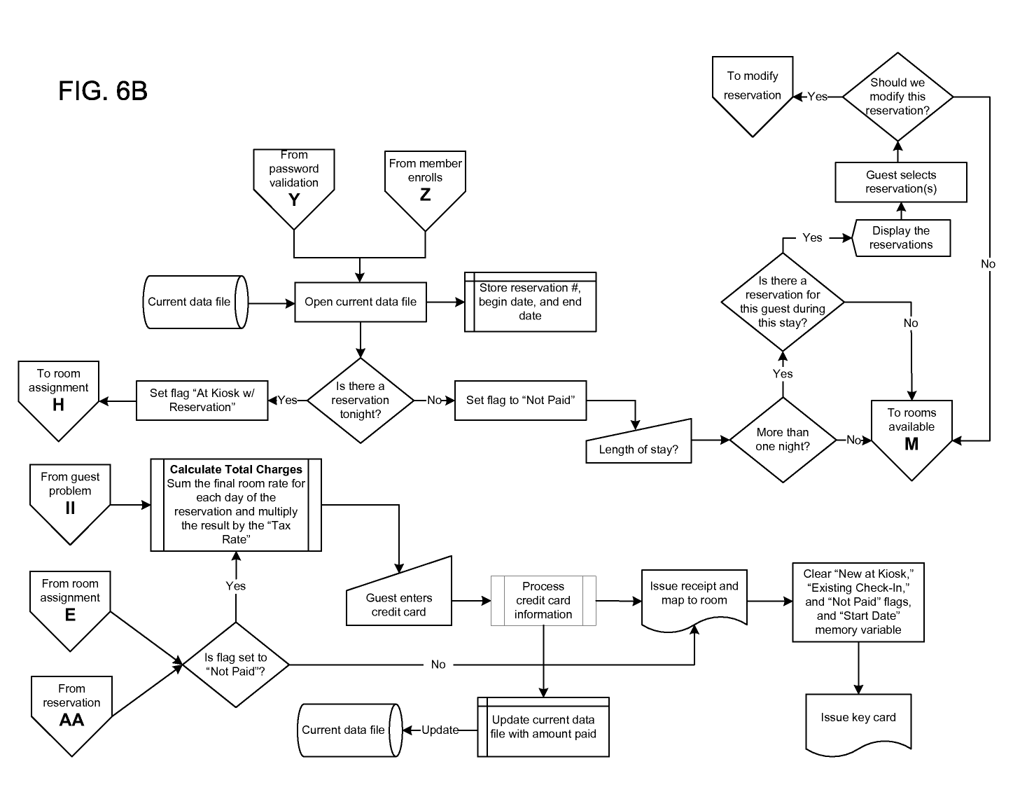

FIGS. 6A and 6B show several functions or requests that a guest can perform at the self-service terminal or kiosk. Functions or requests include, but are not limited to, selecting a language, check-in, making a reservation, obtaining a new key, extending his stay, check-out and getting a complete printed statement of their stay if so desired. In other cases the statement of the stay is emailed to the guest through the RCC 306.

There are different options to the guest, and these can include enrolling or registering in the system if the guest is new. The enrollment or registration process usually only needs to be performed once. Depending on the choice of the guest, the system goes to the proper section of FIGS. 6A and 6B as depicted by the symbols such as Reservation, Guest Problem, Password Validation, Rooms Available, Member Enrolls, Room Assignment, and Issuance of Key card.

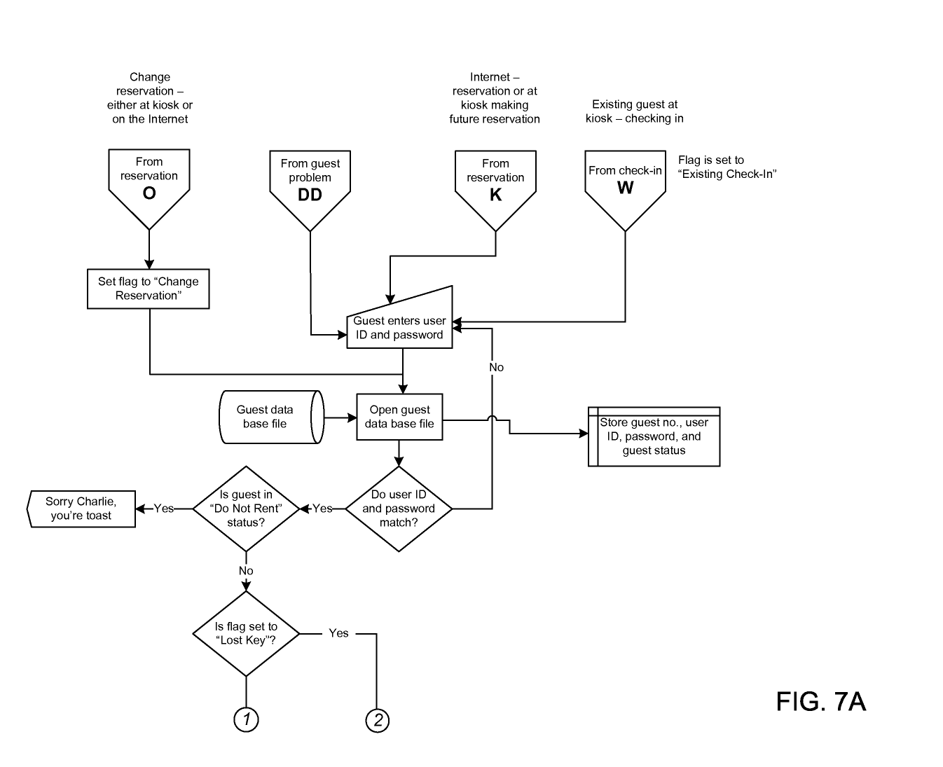

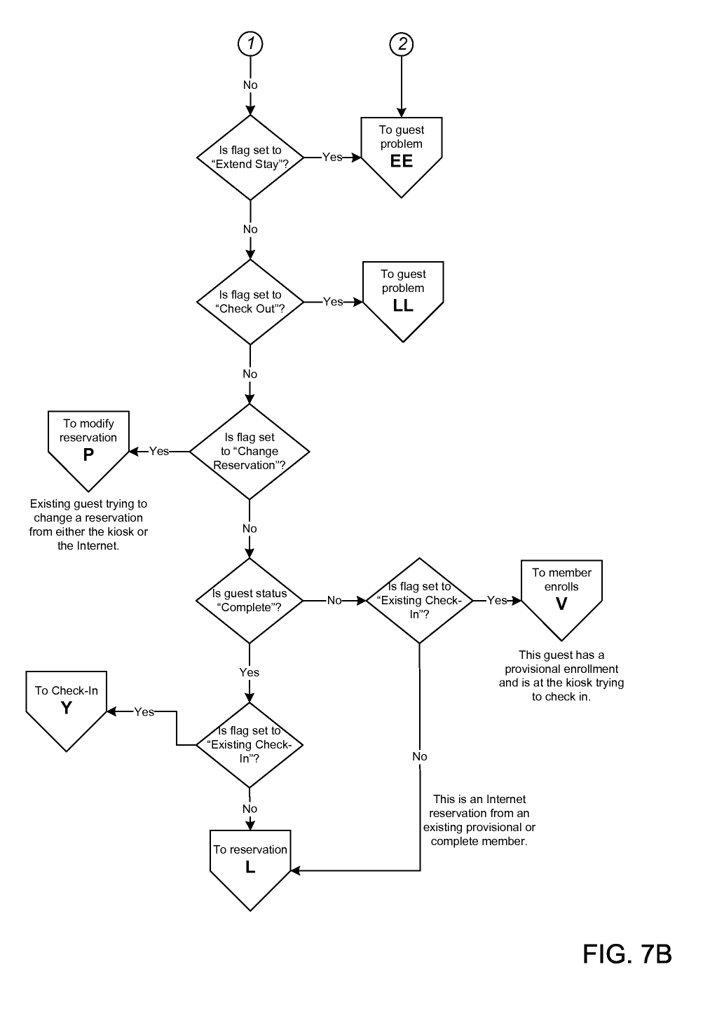

FIGS. 7A and 7B show an example process for validating a guest's password and then permitting the guest to enter the system to perform whatever function or request the guest wishes to perform. This flow diagram is “connected with” the flow diagram of FIGS. 6A and 6B as shown by the appropriate related symbols. The same characteristics of Reservation, Guest Problem, Password Validation, Rooms Available, Member Enrolls, Room Assignment, and Issuance of Key are handled in this manner.

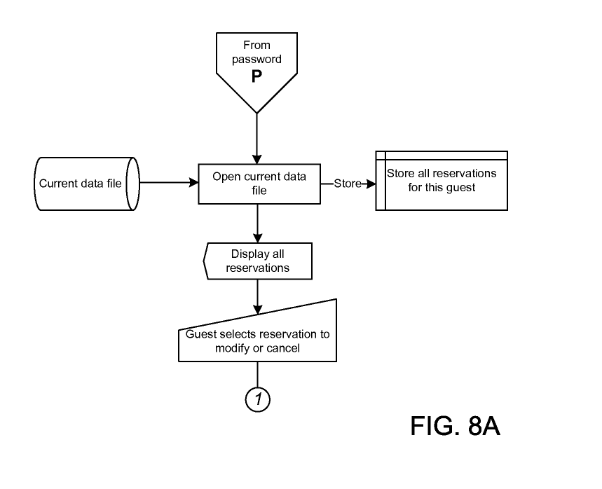

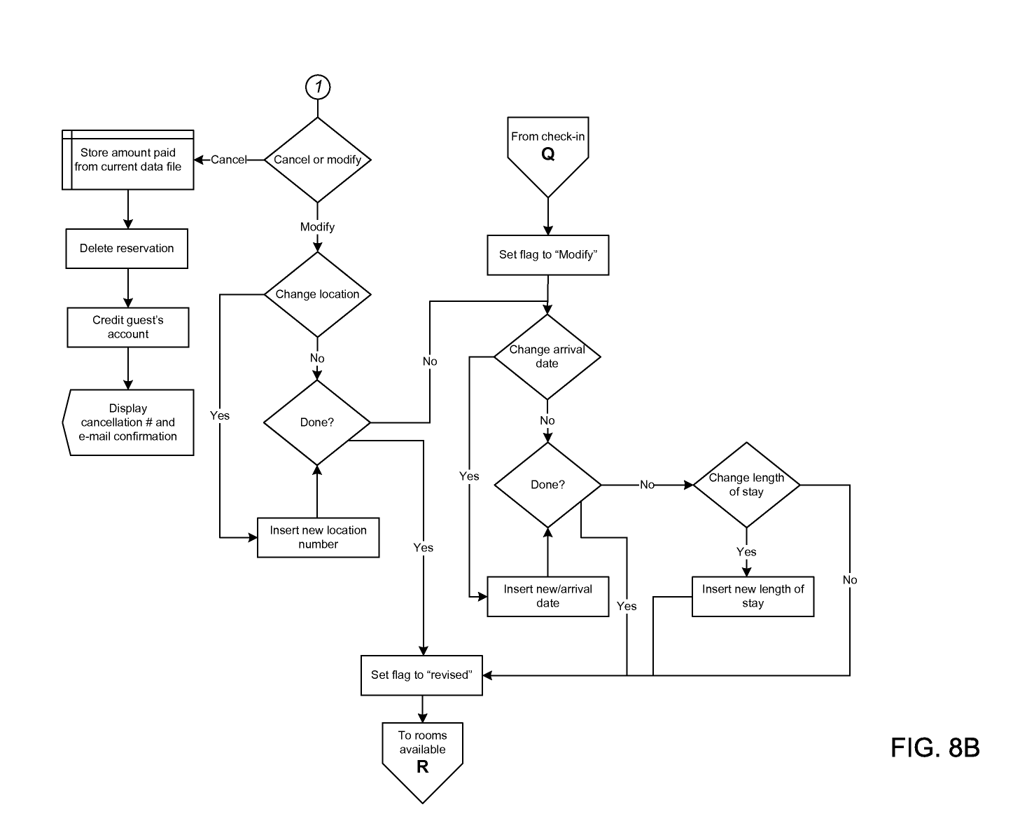

FIGS. 8A and 8B show an example of how the system may determine whether a guest's requested reservation is to be accepted as requested or what alternatives are available to the guest. After entering the system, for instance by password, the characteristics of Reservation, Guest Check-in, Password Validation, Rooms Available, Modifying Stay, Room Assignment, and guest accounting are handled in the manner set out in the flow diagrams of FIGS. 8A and 8B.

These FIGS. 8A and 8B show an example for allowing a guest to modify or cancel a reservation. The guest can do this through various channels, including through the Internet, by calling the RCC and at the self-service terminal or kiosk on any property. Depending on the management policy, the guest may or may not get a full or partial refund.

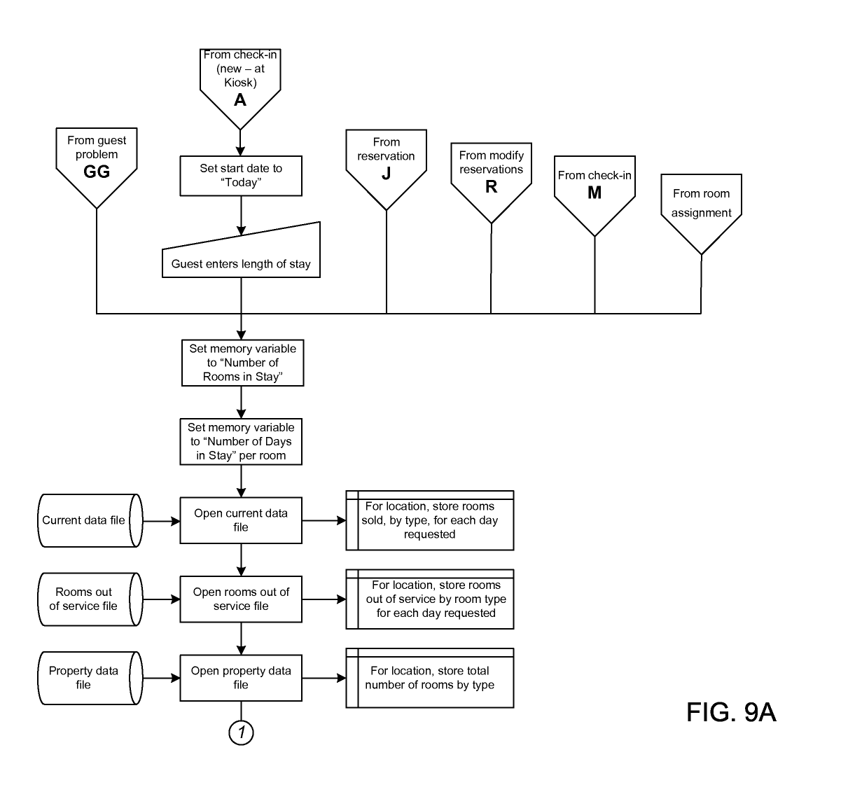

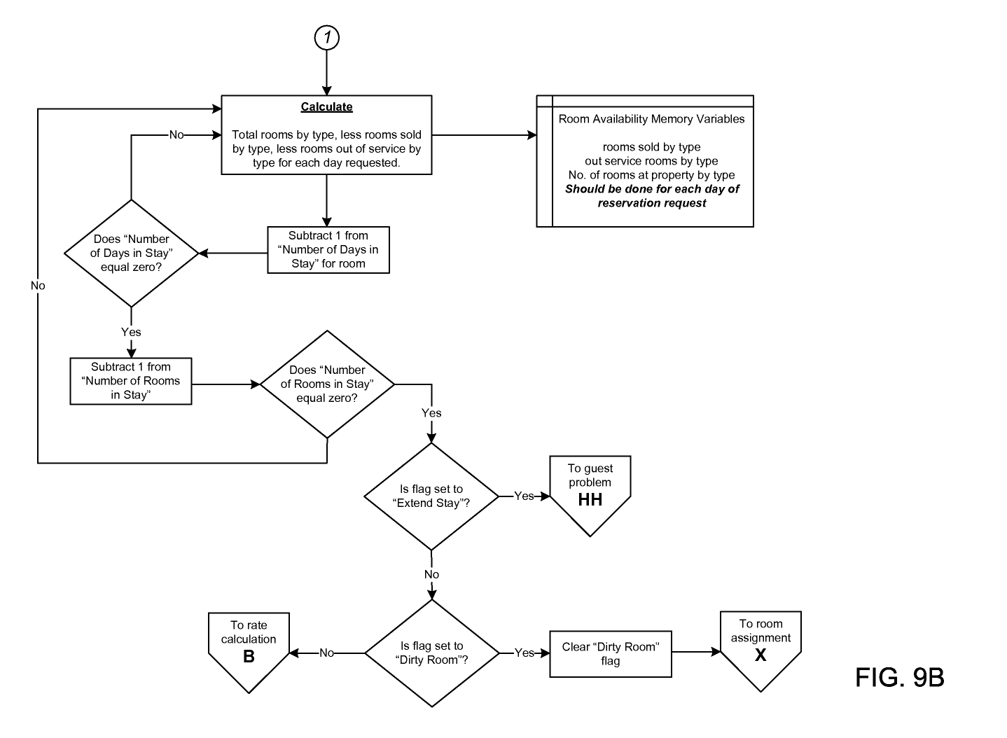

The FIGS. 9A and 9B are flow charts connected to each other showing an example of a process for checking for room availability during a reservation process. It shows this process starting form either a kiosk, from a reservation record, a request at check-in, a guest problem, a room assignment stage or a request to modify a reservation. This is correlated for instance with rooms in service, rooms out of service, rooms which may be dirty, and the desired reservation time periods of a guest.

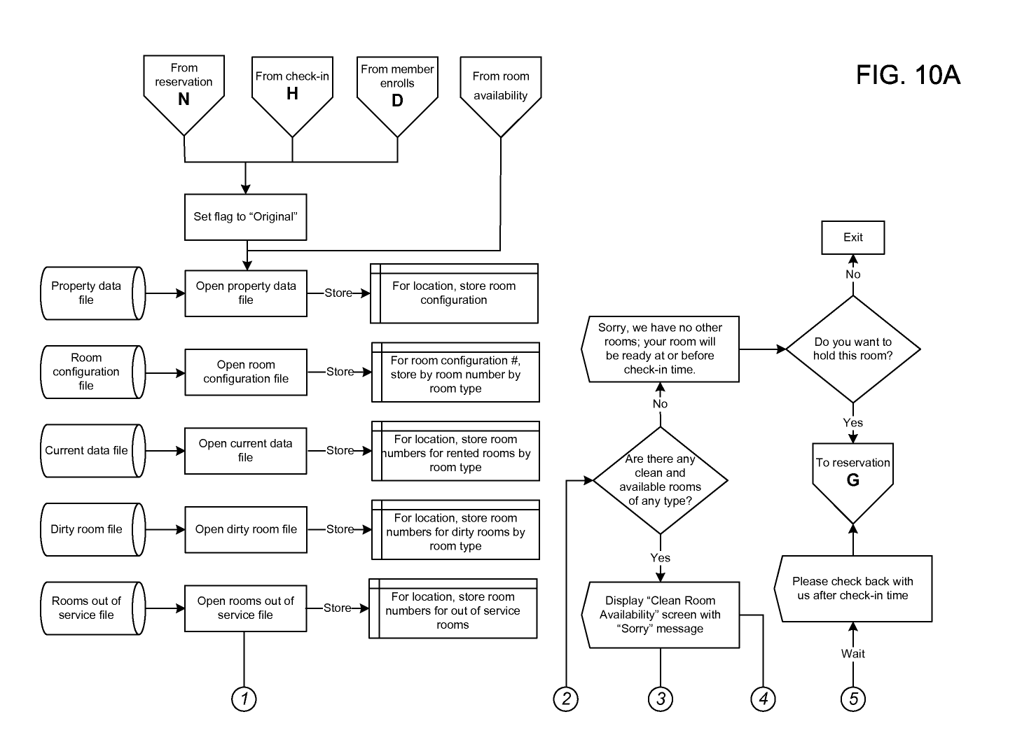

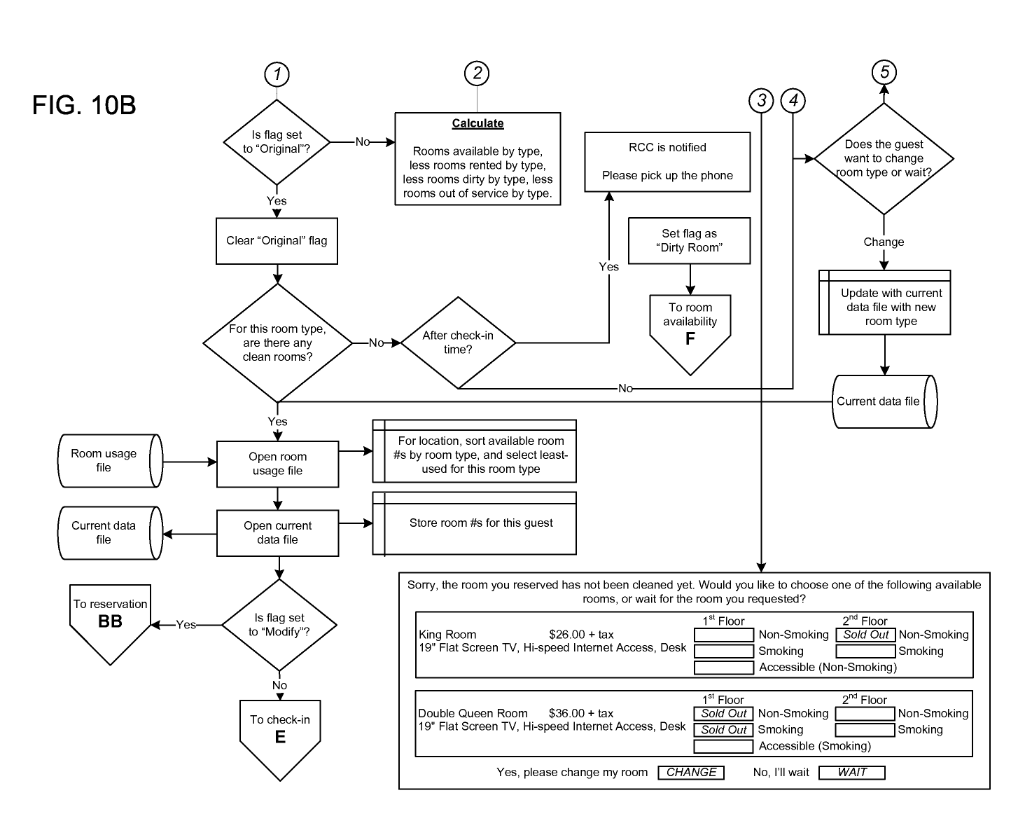

FIGS. 10A and 10B show an example of how a room can be assigned to a guest when the guest checks in. First, the rooms that are available of the type requested are determined by subtracting the rooms of that same type already assigned to guests and the rooms that are out of service. Then it is determined if, of the rooms available, there are any that are clean and available. Once it is determined what rooms of the type requested are available, the system assigns a room based upon an algorithm that takes into consideration any guest preferences and the number of times a particular room has been rented. When rooms are not available there is a message sent to the guest or person trying to reserve the room and an option is given for an alternative type of room.

This process can start from any of multiple points in the procedure. For instance, it can start form the reservation module, check-in module, member enrolls module, and room availability module. In turn through different processes there is access to the property or hotel data file module, the room configuration file module, current data file module, dirty room file module, rooms out of service file module, and room usage file module.

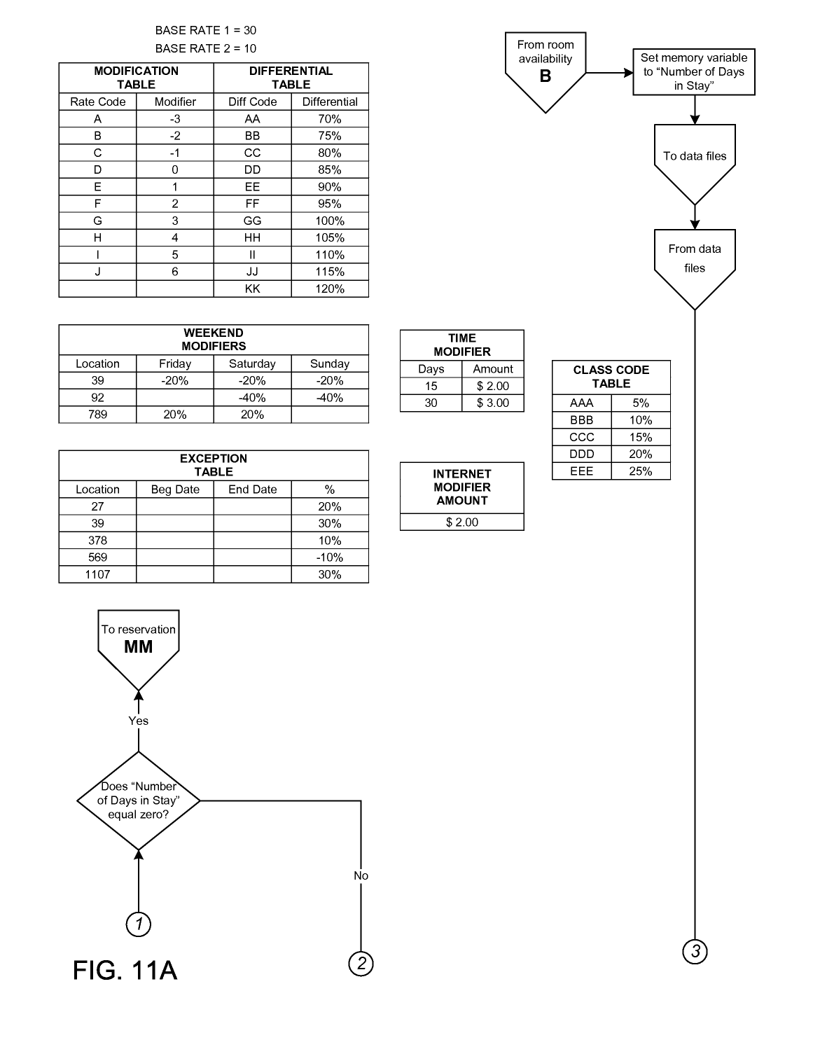

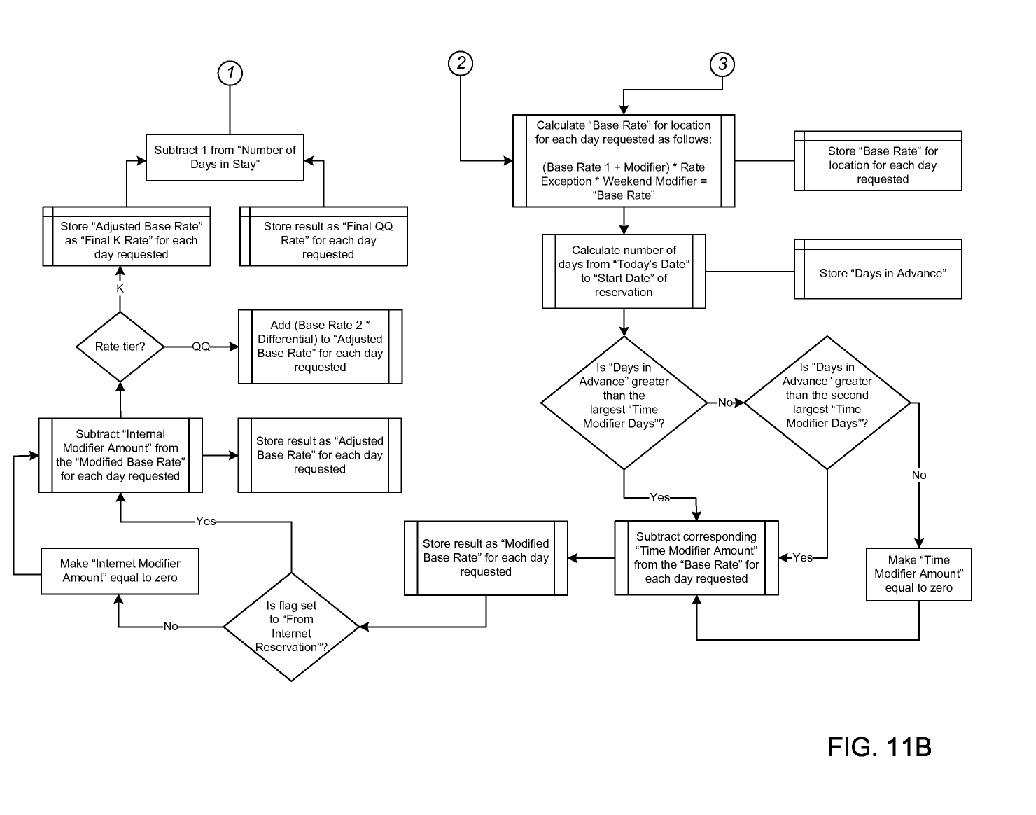

FIGS. 11A and 11B show an example of rate calculations that may be performed for a room. Rates may vary, including but not limited to, from hotel to hotel, by room type, the day of the week, with various exceptions such as special events, whether the reservation was made on the Internet, whether it was made many days in advance, and whether the guest is a member of a group that gets special rate considerations. FIGS. 11A and 11B provide an example of taking all or most of this into consideration on a day-by-day basis in order to determine the total charge for the room. When a guest stays longer at a location rates can be reduced. The system can be set to provide a formulation to give fair profits to the hotel and fair room pricings to the guests. The process starts from a reservation or module or a determination of room availability module.

FIGS. 12A and 12B show an example of how guest problems and issues are handled in a seamless manner through the RCC. A guest may be permitted, after verification of password, to leave early, extend a stay, change rooms, or get a new key. The guest may do this at the kiosk, on the Internet or by telephone to RCC personnel. Accounting can also be adjusted through different processes and calculations.

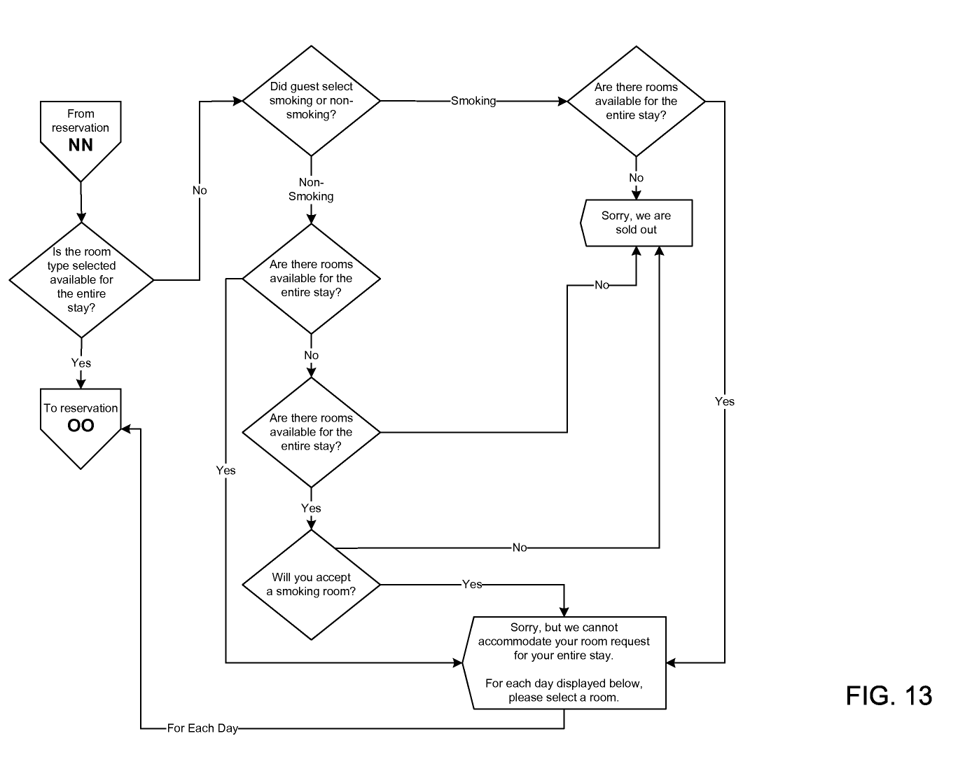

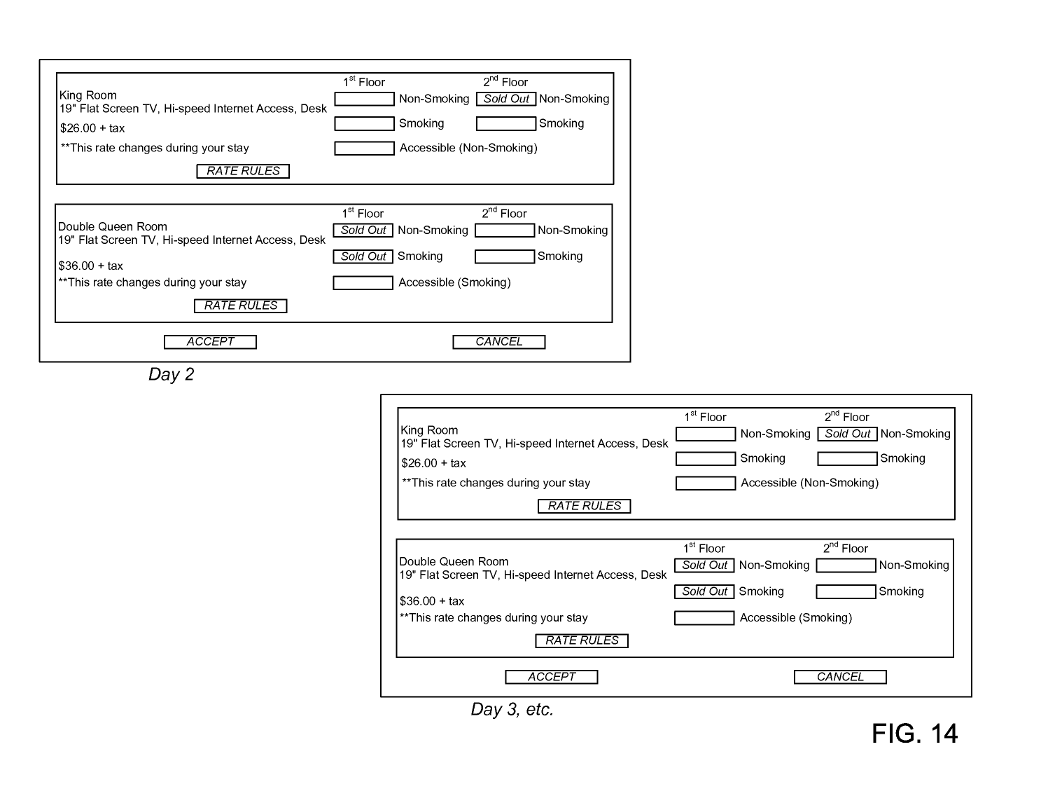

FIGS. 13 and 14 show an example how to deal with the problem of a guest wanting a stay of two or more days but the room type he has selected is available for some but not all of the days requested. The guest can be given the option of taking the requested room for the days it is available and moving to another room when the room the guest is in is no longer available. In FIG. 14 there are two typical screen shots giving a visual presentation to a guest of the room availability and rate characteristics.

Furthermore, the property management system function can include a centralized lock control system. The opening and closing of all internal and external doors may be monitored by the RCC and can also be monitored on closed circuit televisions. The centralized lock control system may detect doors that are left ajar or if there are any forced-entries, and alert the affected hotel as well as the central office. A centralized lock control system would simplify guest check-in procedures as well as key card cancellations upon check-out. If needed, late check-out key card extensions may also be provided remotely. Monitoring all the locks would provide greater guestroom security as well as real-time tracking of hotel employees and detailed, unlimited-access audit trails. There may also be automatic time synchronization of all the locks. Furthermore, the centralized lock control system would provide greater efficiency to individual hotel operations by eliminating incorrect key-card issuances and providing centralized staff and guest card cancellations.

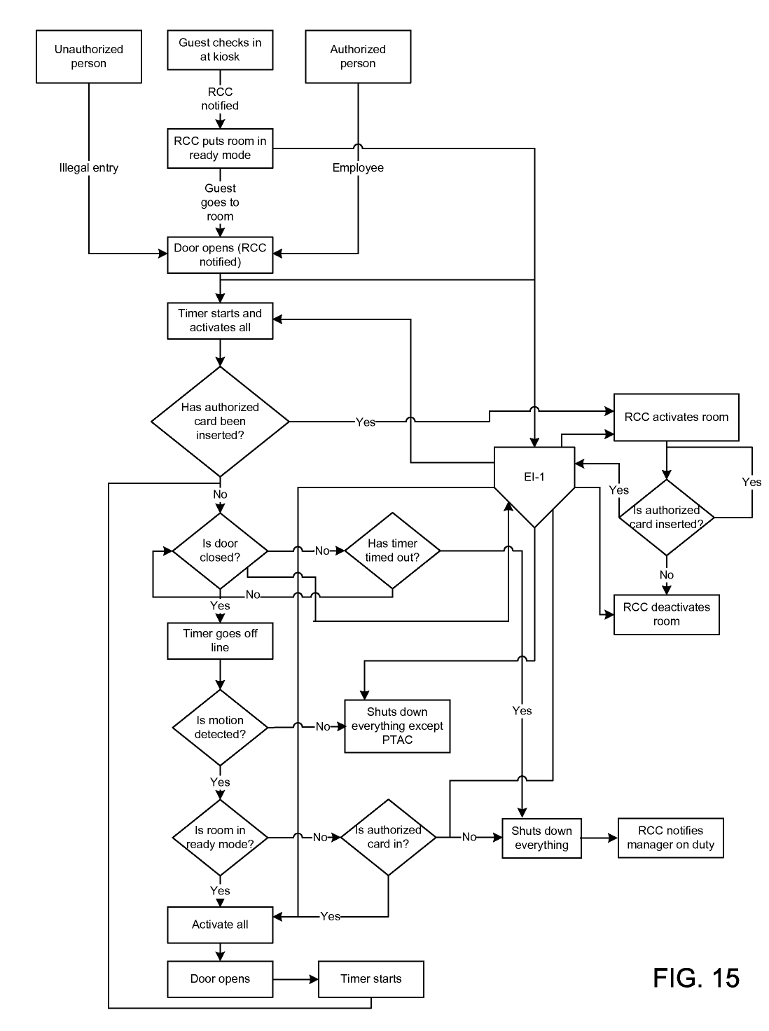

FIG. 15 shows an example of how the system may pick up the fact that the guest room door has been opened by the guest, a member of the staff, or an unauthorized person. The process starts from the possibilities of an unauthorized person illegally entering, a guest legitimately checking in at a kiosk, or an authorized person entering the hotel or units in the hotel.

When the room is rented and the guest has checked in and the door is opened, the system assumes it is the guest that opened the door. However, there is no way to know for sure. If the door closes and motion is detected in the room the system assumes it is the guest.

If however, the user is a member of the staff, they would put their ID card in a card reader so that the RCC would now know which staff member is in the room. On the other hand, if the room is not rented and the door opens, it would be likely that this would be a staff member. In this case they would put their ID card in the reader. There may also be the possibility that the staff member forgets to enter their ID car in the reader, or it is an unauthorized person. Should the staff member forget to place their ID card in the reader, the RCC assumes it is an unauthorized person in the room and notifies the manager.

In addition to the RCC identifying who is in the room and the RCC notifying the manager that corrective action may be necessary, two other things are also accomplished. It would be known if the room is occupied and for security reasons, it would be known if the door remains open or not. If the door remains open beyond a prescribed length of time the manager may be notified. Therefore, the RCC has knowledge of the status of each room at all or most times. This is helpful for housekeeping purposes and essential for security. This same system may also be applied to work for all exterior doors.

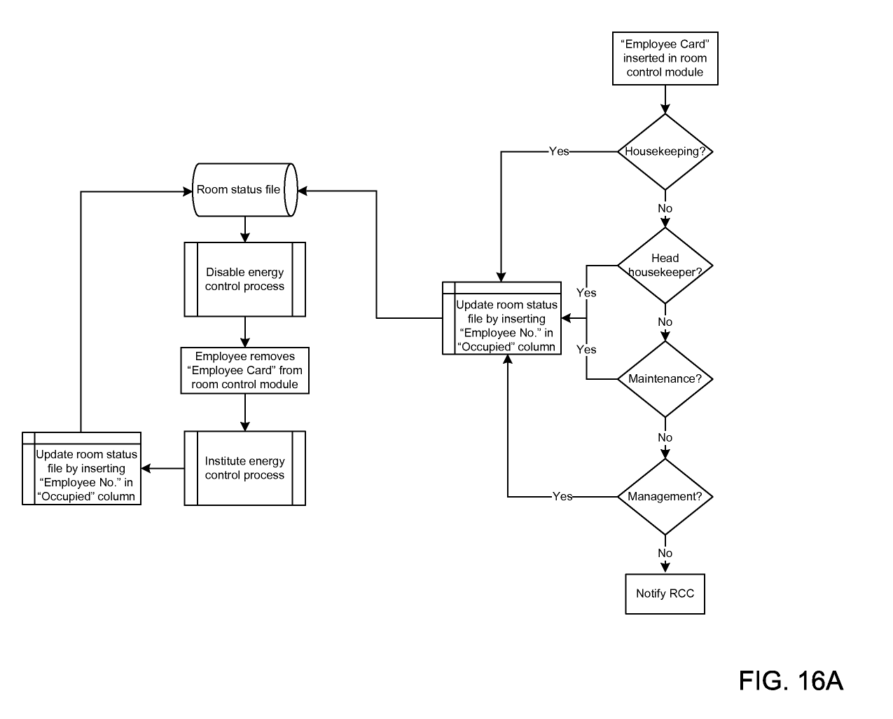

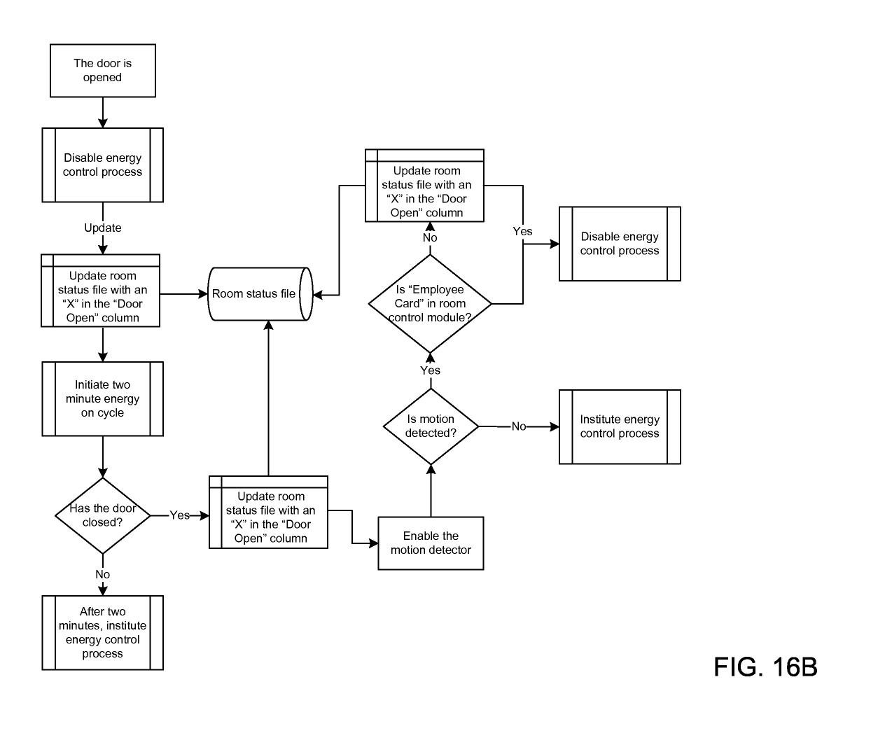

FIGS. 16A and 16B show an example of how a card reader may be used in each room in conjunction with an employee identification card to tell the RCC which employee is in the room. The housekeeper enters their card in the reader and leaves it there while cleaning the room. The RCC makes a note of who it is and when the card was inserted. It notes when the card was withdrawn and calculates the elapsed time. If it is a housekeeper's card and the room had been rented the night before it is assumed that the housekeeper was cleaning the room. The RCC lists the room as “cleaned but not inspected.” If the room has been marked as “cleaned but not inspected” and the executive housekeeper inserts their card and withdraws it, the RCC marks the room “ready to rent”. An entry into the room by either the maintenance department or the manager is also noted by the RCC. By knowing who is in the room, the necessary energy controls may be implemented. A motion detector in strategic locations in the hotel is also used to correlate the electronic records of the status of the location.

For instance if a room should be empty as recorded electronically and motion is detected or a door is ajar, either or both of which may be linked to predetermined time periods, the RCC is notified, and as needed a manager of the hotel, after notification from the RCC, can investigate if this cannot be resolved by squaring the electronic data of the unit. The system provides for dynamic remote control of security of multiple properties of individual units of the multi-unit facility and also the common areas.

In another aspect of the present disclosure, the RCC includes a centralized accounting function. The accounting function may include the handling of all revenue, the collection of funds as well as the payroll and the accounts payable, the preparation of all of the operating financial reports, and the management of cash flow and distributions to owners. Purchasing can also be centralized through the RCC or at the property owner's choice, handled locally.

Databases at the RCC are designed to generate all or most of the operating reports necessary to fulfill the “back office function” such as revenue, bed taxes, occupancy rates, etc. The payroll may come in over the Internet from time clocks on the property and all bills may go to each property, be approved, and then forwarded to the RCC for payment and proper accounting. In this way the RCC prepares the necessary financial reporting for every property in lodging. This avoids the burden of a great deal of accounting that would otherwise be done at the property level, and the expense of the local manager and his staff. It minimizes local reconciling accounts and keeping track of income and expenses, and minimizes the staff distraction from running the hotel and focusing on guest satisfaction.

In one example, a guest can pay for the reservation at the time it is made through the RCC by the use of his credit or debit card. There will be no cash transactions or payments made at the hotel relating to occupancy of the rooms and units.

All or most of the operational accounting including revenue and revenue management, payroll and payables is being done through the RCC. No major accounting should be done at the property or lodging establishment. All operational accounting reports and operational taxes returns will be prepared and filed through the RCC. This could include aspects of current and historic data of reservations, guests, hotels, room type, room number, amounts paid and identification of guests which can include photographic records. Similar data relating to tracking cancellation of reservations can be retained in the RCC. Data about the characteristics of each property can similarly be retained in the RCC. Rate codes, modifications and exceptions can be retained, and details of each room configuration, status in and out of service, cleaned or not cleaned can be retained in the RCC. Bibliographic and profile data of guests can be retained in the RCC.

In another aspect of the present disclosure, the RCC includes a centralized property management system function. The property management system function monitors many aspects of the individual hotel operations and alerts the associated manager of issues that need attention. Security cameras may be located at all critical areas of the hotel and monitored 24/7 by the RCC. Calls from the room to the onsite manager may be routed through the RCC for the appropriate action by trained personnel. Room, hall and exterior lighting as well as heating and air conditioning in the common areas and guest rooms may also be monitored through the RCC.

The property management system function may also gather and manage information such as energy usage, repair requests, and temperature control from the guestrooms. This information may be automatically processed by the property management system to generate historical trends and reports for use by housekeeping, engineering, security and other hotel staff.

Centralization of the multiple functions of multiple hotels may be achieved through the use of the high speed Internet.

In short, a very comprehensive and integrated system is disclosed to centrally control all of the major functions of the hotel, thus leaving the management of the hotel free to focus their attention on managing. It places the major administrative functions of the hotels in the hands of highly trained and well paid staff people backed up by supervisors, managers and the executive staff. The net result of this is major improvements in operational efficiencies and guest satisfaction.

Though the centralized management system has been described mainly as a centralized hotel management system, the centralized management system may be applied in other industries, such as the automotive industries, airline industries, consumer goods industries, food and beverage industries, food service industries, hospitality industries, industrial and wholesale industries, and retail industries.

While the system and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A multi-location management system for hospitality locations each including a multi-unit building, comprising:
a plurality of hospitality locations, being multiple lodging units, the units being connected to a remote control center, the remote control center being located physically separate and removed from the plurality of hospitality locations, the locations each including a multi-unit building, the multiple lodging establishments being part of the plurality of hospitality locations, each of the plurality of hospitality locations including a multi-unit building, and there being multiple separate lodging units in each hospitality location;
wherein the remote control center includes providing remotely controllable and reportable security for the plurality of hospitality locations;
a communication connection for transmitting data between the multi-unit buildings and the remote control center;
task function data transmitted between at least one of the plurality of locations and the remote control center, wherein the task function data is processed at the remote control center, and
a self-service transaction system for facilitating reservation and check-in the lodging establishment comprising:
establishing a personal identification number (PIN) assigned by a computer terminal to a user, the user being at a location remote from the lodging establishment;
recording a request of the user at a self-service terminal at the lodging establishment, the request being at least one of a check-in or check-out request for one of the lodging units; and
performing the request by the self-service terminal if the self-service terminal records entry of a PIN equal to the assigned PIN, the PIN being usable for multiple lodging establishments.

2. A system as claimed in claim 1, wherein the task function data includes data relating to at least one of occupancy data of the multi-unit building, vacancy data of the multi-unit building, and reservation data of the multi-unit building.

3. A system as claimed in claim 1, wherein the task function data includes data relating to the status of individual units concerning whether access doors to respective units are open or closed, and selectively relating opening and closure of unit doors to a predetermined time period, whether access doors to common areas of the multi-unit building are open or closed, and selectively relating opening and closure of common area doors to a predetermined time period.

4. A system as claimed in claim 3, including a camera for monitoring selected doors, and a communication link from the camera to a gateway, and in turn a link to the communication connection with the remote control center.

5. A system as claimed in claim 1, including transmitting reports from the remote control center to the multi-unit building, and wherein the remote control center undertakes delegated operational functions relating to the multi-unit building and thereby there are relatively less operational functions necessary at the multi-unit building, and such delegated functions to the remote control center including at least one of overall accounting for the multi-unit building, data relating to at least one of occupancy data the multi-unit building, vacancy data of the multi-unit building, reservation data of the multi-unit building, status of individual units concerning whether access doors to respective units are open or closed, and selectively relating opening and closure of the unit doors to a predetermined time period, whether access doors to common areas of the multi-unit building are open or closed, and relating opening and closure of the common area doors to a predetermined time period.

6. A system as claimed in claim 5, wherein at least 3 of the operational functions are delegated to the remote control center.

7. A system as claimed in claim 5, wherein at least 6 of the operational functions are delegated to the remote control center.

8. A system as claimed in claim 5, wherein all of the operational functions are delegated to the remote control center.

9. A system as claimed in claim 5, wherein delegating and reporting is effected in substantially real time.

10. A system as claimed in claim 1, wherein the remote control center is a location offsite from the multi-unit building and is an outsourced operation geographically relatively far removed from the multi-unit buildings.

11. A system as claimed in claim 5, wherein the remote control center is a location offsite from the multi-unit building and is an outsourced operation geographically relatively far removed from the multi-unit buildings.

12. A system as claimed in claim 10, wherein the remote control center controls several multi-unit buildings.

13. A system as claimed in claim 11, wherein the remote control center controls several multi-unit buildings.

14. A system as claimed in claim 1, wherein the remote control center is in a location offsite and in a different time zone to at least several of the multi-unit buildings.

15. A system as claimed in claim 5, wherein the remote control center provides an integration service at a location offsite and non-contiguous with several of the multi-unit buildings, and is only in essentially regular telecommunication connection with at least several of the multi-unit buildings, and wherein the service includes the function of at least the accounting services and security services.

16. A system as claimed in claim 1, wherein there is an office staff service provided at the multi-unit buildings, the system being such as prevent the office staff service not dealing with cash transactions relating to guests of the multi-unit buildings and guest account handling of the multi-unit buildings.

17. A centralized multiple hotel management system comprising:
a plurality of hotels connected to a remote control center; each hotel being part of the plurality of hotels, each of the plurality of hotels being remote from the remote control center;
a centralized guest registration function, wherein a remote control center receives data from a guest registration process at any one of a plurality of hotels, and the data is processed at the remote control center;
a centralized reservation function, wherein data from a room reservation process at any one of a plurality of hotels is received at the remote control center and processed at the remote control center;
a centralized guest check-in/check-out function, wherein data from one of a guest check- in or guest check-out process at any one of a plurality of hotels is received at the remote control center and processed at the remote control center;
a centralized accounting function, wherein data from an accounting process for a plurality of hotels is received by the remote control center and processed at the remote control center; and
a centralized property management system function, wherein data from a plurality of hotels is received by the remote control center and processed at the remote control center, and
a self-service transaction system for facilitating reservation and check-in the hotel comprising:
establishing a personal identification number (PIN) assigned by a computer terminal to a user, the user being at a location remote from the hotel;
recording a request of the user at a self-service terminal at the hotel, the request being at least one of a check-in or check-out request; and
performing the request by the self-service terminal if the self-service terminal records entry of a PIN equal to the assigned PIN, the PIN being usable for multiple hotels.

18. (canceled)

19. (canceled)

20. (canceled)

21. A multi-location management system for hospitality locations, each including a multi-unit building, comprising:
a network transceiver resident with a first hospitality location, wherein the network transceiver resident with the first hospitality location is connected to a wide area network;
a network transceiver resident with a second hospitality location, wherein the network transceiver resident with the second hospitality location is connected to the wide area network;
a location-level interface for delivering data from the location-level function resident on the second hospitality location to the network transceiver resident on the second hospitality location;
a remote central server connected to the wide area network, wherein the remote central server receives data from both the network transceiver resident with the first hospitality location and the network transceiver resident with the second hospitality location, and wherein the remote central server integrates said data from both the network transceiver resident with the first hospitality location and the network transceiver resident with the second hospitality location for delivery to a central services application;
a user interface for accessing the central services application and exchanging data between the remote central server and a user; and
the data includes data relating to the status of individual units concerning whether access doors to respective units are open or closed, and relating opening and closure of unit doors to a predetermined time period, whether access doors to common areas of the multi-unit building are open or closed, and relating opening and closure of common area doors to a predetermined time period.

22. A multi-location management system for hospitality locations, each including a multi-unit building, comprising:
a network transceiver resident with a first hospitality location, wherein the network transceiver resident en with the first hospitality location is connected to a wide area network;
data being deliverable from the the first hospitality location to the network transceiver resident with the first hospitality location;
a network transceiver resident with a second hospitality location, wherein the network transceiver resident with the second hospitality location is connected to the wide area network;
data being deliverable from the second hospitality location to the network transceiver resident with the second hospitality location;
a remote central server connected to the wide area network, wherein the remote central server receives data from both the network transceiver resident with the first hospitality location and the network transceiver resident with the second hospitality location, and wherein the remote central server integrates said data from both the network transceiver resident with the first hospitality location and the network transceiver resident with the second hospitality location for delivery to a central services application;
a user interface for accessing the central services application and exchanging data between the remote central server and a user; and
transmitting reports from a remote control center to the multi-unit building, and wherein the remote control center undertakes delegated operational functions relating to the first and second hospitality locations and thereby there are relatively less operational functions necessary at the locations, and such delegated functions to the remote control center including at least one of overall accounting for the locations, data relating to at least one of occupancy data of the locations, vacancy data of the locations, reservation data of the locations, status of individual units concerning whether access doors to respective units are open or closed, and preferably relating opening and closure of the unit doors to a predetermined time period, whether access doors to common areas of the locations are open or closed, and relating opening and closure of the common area doors.

23. A system as claimed in claim 22, wherein at least 3 of the operational functions are delegated to the remote control center.

24. A system as claimed in claim 22, wherein at least 6 of the operational functions are delegated to the remote control center.

25. A system as claimed in claim 22, wherein all of the operational functions are delegated to the remote control center.

26. A centralized multiple hotel management system comprising:
a plurality of hotel locations each including a multi-unit building connected to a remote control center, the remote control center being located geographically separately from the plurality of locations, wherein the remote control center includes providing remotely reportable security for the plurality of locations;
a centralized guest registration function, wherein data from a guest registration process at a hotel is received by the remote control center and processed at the remote control center;
a centralized reservation function, wherein data from a room reservation process is received by the remote control center and processed at the remote control center, the data from the room reservation process including a personal identification number (PIN) assigned by a computer terminal to a guest;
a centralized guest check-in/check-out function, wherein data from one of a guest check-in and guest check-out process at a hotel is received by the remote control center and processed at the remote control center, the at least one of a guest check-in and guest check-out process data being received from a self-service terminal located at the hotel, the self-service terminal performing one of a guest check-in and guest check-out process if the self-service terminal records entry of data equal to an assigned data record, the data record being usable for multiple hotel establishments;
a centralized accounting function, wherein data from an accounting process at a hotel is received by the remote control center and processed at the remote control center; and
a centralized property management system function, wherein data from the hotel operation process at the hotel is received by the remote control center and processed at the remote control center.

27. A system as claimed in claim 26, wherein the assigned data record is at least one of personal identification number (PIN), credit card or debit card information, or bar code information.

28. A system as claimed in claim 26, wherein the management function includes reports from a remote control center to the hotel locations, and wherein the remote control center undertakes delegated operational functions relating to the hotel locations and thereby there are relatively less operational functions necessary at the hotel locations, and such delegated functions to the remote control center including at least one of overall accounting for the locations, data relating to at least one of occupancy data of the hotel locations, vacancy data of the hotel locations, reservation data of the hotel locations, status of individual units concerning whether access doors to respective units are open or closed, and preferably relating opening and closure of the unit doors to a predetermined time period, whether access doors to common areas of the locations are open or closed, and relating opening and closure of the common area doors.

29. A system as claimed in claim 26, wherein the system is such as prevent the hotel locations from interacting with monetary currency between guests of the units relating to guests of the hotel and guest account handling of the hotel.

30. A system as claimed in claim 26, wherein the hotel locations are established so as not to provide a common area kitchen or dining room.

31. A system as claimed in claim 1, wherein the remote control center being located physically separate and removed from the plurality of hospitality locations, and wherein a user at the self service terminal communicates with the remote control center selectively by at least one of a keying entry, scanning or a dedicated telephone connection.

32. A system as claimed in claim 1, wherein the remote control center is located physically separate and removed from the plurality of hospitality locations, and wherein a user at the self service terminal communicates during check-in with the remote control center selectively by at least one of a keying entry or scanning in addition to a facility to communicate through a dedicated telephone connection.

33. A system as claimed in claim 28, wherein the system is such as prevent the hotel locations from interacting with monetary currency between guests of the units relating to guests of the hotel and guest account handling of the hotel.

34. A system as claimed in claim 33, wherein the hotel locations are established so as not to provide a common area kitchen or dining room.
